(19) United States
(12) Patent Application Publication
(10) Pub. No.: US 2014/0226330 A1
(43) Pub. Date: Aug. 14, 2014

(54) LIGHT EMITTING DEVICES AND METHODS OF MANUFACTURING AND CONTROLLING THEREOF

(71) Applicant: Samsung Electronics Co., Ltd., Suwon-si (KR)

(72) Inventor: Hyeong Won Yun, Yongin-si (KR)

(73) Assignee: Samsung Electronics Co., Ltd., Suwon-si (KR)

(21) Appl. No.: 14/172,281

(22) Filed: Feb. 4, 2014

(30) Foreign Application Priority Data
Feb. 8, 2013 (KR) 10-2013-0014637

(51) Int. Cl. F21V 21/00; F21V 21/14; F21V 5/00

(52) U.S. Cl. CPC F21V 21/00; F21V 5/00; F21V 21/14
USPC 362/235; 362/249.14; 362/249.08

(57) ABSTRACT

A light emitting device including a substrate having first and second power terminals, the substrate constructed and arranged to at least partially surround an inner region, the substrate having an inner surface that faces the inner region and an outer surface opposite the inner region; and a plurality of light emitting elements positioned on the outer surface of the flexible substrate and electrically connected to the first and second power terminals, the plurality of light emitting elements positioned on the outer surface so that first and second ones of the light emitting elements are arranged to emit light radiation that is substantially oriented in first and second different radial directions, respectively, relative to the inner region, may be provided.

### CROSS-REFERENCE TO RELATED APPLICATIONS

This application claims the priority of Korean Patent Application No. 2013-0014637 filed on Feb. 8, 2013 in the Korean Intellectual Property Office, the disclosure of which is incorporated herein by reference in its entirety.

### BACKGROUND

1. Field

The present disclosure relates to lighting devices, illumination devices, and methods of manufacture thereof.

2. Description of Related Art

In view of the recent trend toward regulation of the use of incandescent lamps due to their inefficiencies, in order to save energy, light emitting diodes (LED), consuming relatively lower amounts of power per generated lumen, and having greater durability, have come to prominence worldwide as a modern substitute light source.

However, since an LED element emits light from only one side thereof, a majority of light is irradiated in a certain direction, for example in a forward direction. As a result, there may be no rearward light distribution therefrom. LED-based lighting sources therefore generally lack the ability to implement near-spherical illumination in the manner of an incandescent lamp. With this shortcoming in mind, in many situations, LED-based lighting sources cannot be considered to be a direct substitute for existing incandescent lamps.

Thus, research into a lighting device capable of implementing rearward light distribution, in the manner of an incandescent lamp, has been conducted.

### SUMMARY

Exemplary embodiments provide a lighting device capable of implementing rearward light distribution, like that of an existing incandescent lighting source, while employing a light emitting diode (LED) as a light source thereof.

In an aspect, a light emitting device comprises: a flexible substrate having first and second power terminals, the flexible substrate constructed and arranged to at least partially surround an inner region, the flexible substrate having an inner surface that faces the inner region and an outer surface opposite the inner region; and a plurality of light emitting elements positioned on the outer surface of the flexible substrate and electrically connected to the first and second power terminals, the plurality of light emitting elements positioned on the outer surface so that first and second ones of the light emitting elements are arranged to emit light radiation that is substantially oriented in first and second different radial directions, respectively, relative to the inner region.

In some embodiments, a vertical axis of the device intersects the inner region and wherein the plurality of light emitting elements are positioned on a common plane that intersects the vertical axis.

In some embodiments, the first and second radial directions are relative to a vertical axis of the device and wherein all of the light emitting elements of the device are positioned exclusively a single common plane that is normal to the vertical axis.

In some embodiments, the light emitting device further comprises a light spreading unit positioned to receive incident light radiation in the first and second radial directions from the first and second light emitting elements.

In some embodiments, the light spreading unit comprises an intermediate opening having an inner surface and wherein the flexible substrate including the first and second light emitting elements is positioned in the intermediate opening so that the light radiation from the first and second light emitting elements is incident on the inner surface of the intermediate opening.

In some embodiments, a shape of the intermediate opening corresponds with a shape of the flexible substrate.

In some embodiments, the shape of the intermediate opening is circular.

In some embodiments, the shape of the intermediate opening is one of three-sided, four-sided, five-sided, six-sided, seven-sided, eight-sided, nine-sided, or ten-sided, or greater-than-ten-sided.

In some embodiments, the light emitting device further comprises light refractive structures at the intermediate opening.

In some embodiments, the light refractive structures have positions that correspond with positions of the light emitting elements.

In some embodiments, the light spreading unit further comprises an upper surface and a lower surface and wherein at least one of the upper surface and lower surface is curved so as to redirect internally propagating light.

In some embodiments, the curved surface is constructed and arranged so that the light spreading unit has a thickness that is greatest at an intermediate portion thereof and that is least at an outer portion thereof.

In some embodiments, the lower surface is curved and wherein the upper surface is substantially planar.

In some embodiments, the light emitting device further comprises a reflector at the lower surface to reflect the internally propagating light.

In some embodiments, the light spreading unit comprises a unitary disc including the intermediate opening.

In some embodiments, the light spreading unit comprises a substantially toroidal structure including the intermediate opening.

In some embodiments, a body of the toroidal structure is hollow.

In some embodiments, the light spreading unit is removably coupled to the light emitting device.

In some embodiments, the light emitting device further comprises multiple light spreading units, each having different optical features and each removably coupled to the light emitting device.

In some embodiments, the light emitting device further comprises a securing unit that removably couples the light spreading unit to the light emitting device.

In some embodiments, the light spreading unit has an outer surface that is circular in shape.

In some embodiments, the light spreading unit has an outer surface having a shape that is one of is one of three-sided, four-sided, five-sided, six-sided, seven-sided, eight-sided, nine-sided, or ten-sided, or greater-than-ten-sided.

In some embodiments, the flexible substrate has a circular outer shape.

In some embodiments, the flexible substrate has an outer shape that is one of three-sided, four-sided, five-sided, six-sided, seven-sided, eight-sided, nine-sided, or ten-sided, or greater-than-ten-sided.

In some embodiments, the light emitting device further comprises a base at a first end of the light emitting device, the base having first and second terminals electrically insulated from each other, the first and second power terminals of the flexible substrate electrically connected to the first and second terminals of the base; a light-spreading unit positioned to receive incident light radiation from the first and second light emitting elements; and a heat dissipating unit that dissipates heat generated by the light emitting device, a portion of the heat dissipating unit at an outermost second end of the light emitting device distal the first end.

In some embodiments, the light emitting device further comprises: a base at a first end of the light emitting device, the base having first and second terminals electrically insulated from each other, the first and second power terminals of the flexible substrate electrically connected to the first and second terminals of the base; a light-spreading unit positioned to receive incident light from the first and second light emitting elements; and a heat dissipating unit that dissipates heat generated by the light emitting device, the light spreading unit being positioned at a vertical position along a vertical axis of the light emitting device between the heat dissipating unit and the base.

In some embodiments, the light emitting device further comprises a controller configured to independently activate and deactivate the first and second light emitting elements respectively in response to a control signal.

In some embodiments, the control signal is generated in response to a color temperatures of the first and second light emitting elements.

In another aspect, a light emitting device comprises: a light source constructed and arranged to emit electromagnetic radiation in a radial direction relative to a first axis; and a light spreading unit including an upper surface, a lower surface and an intermediate opening, the light spreading unit positioned to receive and internally propagate incident electromagnetic radiation from the light source at the intermediate opening, at least one of the upper surface and the lower surface being curved as so to redirect the internally propagating electromagnetic radiation.

In some embodiments, the intermediate opening includes an inner surface and wherein the light source is positioned in the intermediate opening so that emitted electromagnetic radiation is incident on the inner surface of the intermediate opening.

In some embodiments, a shape of the intermediate opening is circular.

In some embodiments, a shape of the intermediate opening is one of three-sided, four-sided, five-sided, six-sided, seven-sided, eight-sided, nine-sided, or ten-sided, or greater-than-ten-sided.

In some embodiments, the light emitting device further comprises light refractive structures at the intermediate opening.

In some embodiments, the light refractive structures have positions that correspond with positions of light emitting elements of the light emitting device.

In some embodiments, the curved surface is constructed and arranged so that the light spreading unit has a thickness that is greatest at an intermediate portion thereof and that is least at an outer portion thereof.

In some embodiments, the lower surface is curved and wherein the upper surface is substantially planar.

In some embodiments, the light emitting device further comprises a reflector at the lower surface to reflect the internally propagating light.

In some embodiments, the light spreading unit comprises a unitary disc including the intermediate opening.

In some embodiments, the light spreading unit comprises a substantially toroidal structure including the intermediate opening.

In some embodiments, a body of the toroidal structure is hollow.

In some embodiments, the light spreading unit is removably coupled to the light emitting device.

In some embodiments, the light emitting device further comprises multiple light spreading units, each having different optical features and each removably coupled to the light emitting device.

In some embodiments, the light emitting device further comprises a securing unit that removably couples the light spreading unit to the light emitting device.

In some embodiments, the light spreading unit has an outer surface that is circular in shape.

In some embodiments, the light spreading unit has an outer surface having a shape that is one of is one of three-sided, four-sided, five-sided, six-sided, seven-sided, eight-sided, nine-sided, or ten-sided, or greater-than-ten-sided.

In some embodiments, the light source comprises a flexible substrate.

In some embodiments, the light source comprises light emitting elements, and wherein the elements are positioned exclusively on a single common plane that is normal to the first axis.

In some embodiments, the light emitting device further comprises: a base at a first end of the light emitting device, the base having first and second terminals electrically insulated from each other, the first and second power terminals of the flexible substrate electrically connected to the first and second terminals of the base; a light-spreading unit positioned to receive incident light radiation from the first and second light emitting elements; and a heat dissipating unit that dissipates heat generated by the light emitting device, a portion of the heat dissipating unit at an outermost second end of the light emitting device distal the first end.

In an aspect, a light emitting device, comprises: a base having first and second power terminals electrically insulated from each other; a light source having a plurality of light emitting elements connected to the first and second terminals, the light source constructed and arranged to emit electromagnetic radiation in a radial direction relative to a first axis, all of the light emitting elements of the light source being positioned exclusively along a single plane that is normal to the first axis; and a light spreading unit including an upper surface, a lower surface and an intermediate opening, the light spreading unit positioned about the light source to receive and distribute incident electromagnetic radiation from the light source at the intermediate opening.

In some embodiments, the light source comprises a flexible substrate.

In some embodiments, at least one of the upper surface and lower surface of the light spreading unit is curved so as to redirect internally propagating light.

In some embodiments, the base is at a first proximal end and the light emitting device further comprises a heat dissipating unit that dissipates heat generated by the light source, a portion of the heat dissipating unit at an outermost second end of the light emitting device distal the first end.

In some embodiments, the light spreading unit is removably coupled to the light emitting device.

In another aspect, a light emitting device, comprises: a base at a first end having first and second terminals electrically insulated from each other; a light source having a plurality of light emitting elements connected to the first and second terminals, the light source constructed and arranged to emit electromagnetic radiation in a radial direction relative to a first axis, a light-spreading unit including an upper surface, a lower surface and an intermediate opening, the light spreading unit positioned to receive incident electromagnetic radiation from the light source at the intermediate opening; and a heat dissipating unit, a portion of the heat dissipating unit at an outermost second end of the light emitting device distal the first end.

In some embodiments, the light spreading unit being positioned at a position along the first axis of the light emitting device between the heat dissipating unit and the base.

In some embodiments, the light source comprises a flexible substrate.

In some embodiments, at least one of the upper surface and lower surface of the light spreading unit is curved so as to redirect internally propagating light.

In some embodiments, the light source comprises light emitting elements, and wherein the elements are positioned exclusively on a single common plane that is normal to the first axis.

In some embodiments, the light spreading unit is removably coupled to the light emitting device.

In an aspect, a light emitting device comprises: a base having first and second terminals electrically insulated from each other; a light source having a plurality of light emitting elements connected to the first and second terminals, the light source constructed and arranged to emit electromagnetic radiation in a radial direction relative to a first axis; a light-spreading unit including an upper surface, a lower surface and an intermediate opening, the light spreading unit positioned to receive incident electromagnetic radiation from the light source at the intermediate opening; and wherein the light source is removably coupled to the base by a securing feature, the light spreading unit constructed and arranged to be removably coupled by the light source to the base.

In some embodiments, the base further comprises a housing unit, the light source and the light spreading unit being removably coupled to the housing unit.

In some embodiments, the light source comprises a flexible substrate.

In some embodiments, at least one of the upper surface and lower surface of the light spreading unit is curved so as to redirect internally propagating light.

In some embodiments, the light source comprises light emitting elements, and wherein the elements are positioned exclusively on a single common plane that is normal to the first axis.

In some embodiments, the light emitting device further comprises a heat dissipating unit, a portion of the heat dissipating unit at an outermost second end of the light emitting device distal the first end.

In some embodiments, the light spreading unit is positioned at a position along the first axis of the light emitting device between the heat dissipating unit and the base.

In an aspect, a light emitting device, comprises: a base at a first end having first and second terminals electrically insulated from each other; a light source having a plurality of light emitting elements connected to the first and second terminals, the light source constructed and arranged to emit electromagnetic radiation in a radial direction relative to a first axis, wherein the light source comprises light emitting elements, and wherein the elements are positioned exclusively on a single common plane that is normal to the first axis; a light-spreading unit including an upper surface, a lower surface and an intermediate opening, the light spreading unit positioned to receive incident electromagnetic radiation from the light source at the intermediate opening, the light spreading unit comprising a substantially toroidal structure; and a heat dissipating unit, a portion of the heat dissipating unit at an outermost second end of the light emitting device distal the first end.

In some embodiments, a body of the toroidal structure is hollow.

In some embodiments, the light source comprises a flexible substrate.

In some embodiments, the light source comprises light emitting elements, and wherein the elements are positioned exclusively on a single common plane that is normal to the first axis.

In some embodiments, the light emitting device further comprises a heat dissipating unit, a portion of the heat dissipating unit at an outermost second end of the light emitting device distal the first end.

In some embodiments, the light spreading unit is removably coupled to the light emitting device.

### BRIEF DESCRIPTION OF THE DRAWINGS

The above and/or other aspects will be more clearly understood from the following detailed description taken in conjunction with the accompanying drawings, in which:

FIG. 1 is a schematic side view of a lighting device according to an exemplary embodiment;

FIG. 2 is an exploded perspective view schematically illustrating the lighting device of FIG. 1;

FIG. 3 is a cross-sectional view schematically illustrating an exemplary embodiment of a substrate that may be employed in the lighting device;

FIG. 4 is a cross-sectional view schematically illustrating another embodiment of the substrate;

FIG. 5 is a cross-sectional view schematically illustrating a substrate according to a modification of the embodiment of FIG. 4;

FIGS. 6 through 9 are cross-sectional views schematically illustrating various embodiments of the substrate; FIGS. 7a and 7b are sectional and plan views of another example of a board.

FIG. 10 is a cross-sectional view schematically illustrating an example of a light emitting element (LED chip) that may be employed in a lighting device according to an exemplary embodiment;

FIG. 11 is a cross-sectional view schematically illustrating another example of the light emitting element (LED chip) of FIG. 10;

FIG. 12 is a cross-sectional view schematically illustrating another example of the light emitting element (LED chip) of FIG. 10;

FIG. 13 is a cross-sectional view illustrating an example of an LED chip mounted on a mounting substrate, as a light emitting element (LED chip) that may be employed in a lighting device according to an exemplary embodiment;

FIG. 14 is a cross-sectional view illustrating an example (chip-scale package) of a light emitting element package that may be employed in a lighting device according to an exemplary embodiment;

FIG. 15 is a perspective view schematically illustrating another example (a side view package) of the light emitting element package of FIG. 14;

FIG. 16 is a CIE 1931 chromaticity diagram;

FIG. 17 is a cross-sectional view schematically illustrating light emitting elements mounted on the substrate in FIG. 2;

FIG. 18A is a view schematically illustrating a surface intensity of illumination of a lighting device according to an embodiment of the present inventive concepts;

FIG. 18B is a graph schematically showing a light distribution curve;

FIG. 19 is a side view schematically illustrating a modification of a light spreading unit of FIG. 1;

FIGS. 20(a) through 20(d) are plan views schematically illustrating a modification of the light spreading unit of the embodiment of FIG. 1;

FIGS. 21(a) through 21(d) are plan views schematically illustrating another modification of the light spreading unit of the embodiment of FIG. 1;

FIG. 22A is a plan view schematically illustrating another embodiment of the light spreading unit of the embodiment of FIG. 1;

FIG. 22B is a view illustrating a light path in FIG. 22A;

FIG. 23A is a view schematically illustrating a surface intensity of illumination of the light emitting element according to the embodiment of FIG. 22A;

FIG. 23B is a graph depicting a light distribution curve;

FIG. 24 is a perspective view schematically illustrating a lighting device according to another embodiment of the present inventive concepts;

FIG. 25 is an exploded perspective view schematically illustrating the lighting device of FIG. 24;

FIGS. 26A and 26B are exploded perspective views schematically illustrating various embodiments of a light spreading unit of the lighting device of FIG. 25;

FIG. 27 is a graph showing a light distribution curve;

FIG. 28 is a block diagram schematically illustrating a lighting system according to an embodiment of the present inventive concepts;

FIG. 29 is a block diagram schematically illustrating a detailed configuration of a lighting unit of the lighting system illustrated in FIG. 28;

FIG. 30 is a flow chart illustrating a method for controlling the lighting system illustrated in FIG. 28;

FIG. 31 is a view schematically illustrating the use of the lighting system illustrated in FIG. 28;

FIG. 32 is a block diagram of a lighting system according to another embodiment of the present inventive concepts;

FIG. 33 is a view illustrating a format of a ZigBee signal according to an embodiment of the present inventive concepts.

FIG. 34 is a view illustrating a sensing signal analyzing unit and an operation control unit according to an embodiment of the present inventive concepts;

FIG. 35 is a flow chart illustrating an operation of a wireless lighting system according to an embodiment of the present inventive concepts;

FIG. 36 is a block diagram schematically illustrating constituent elements of a lighting system according to another embodiment of the present inventive concepts;

FIG. 37 is a flow chart illustrating a method for controlling a lighting system;

FIG. 38 is a flow chart illustrating a method for controlling a lighting system according to another embodiment of the present inventive concepts; and

FIG. 39 is a flow chart illustrating a method for controlling a lighting system according to another embodiment of the present inventive concepts.

### DETAILED DESCRIPTION OF EMBODIMENTS

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

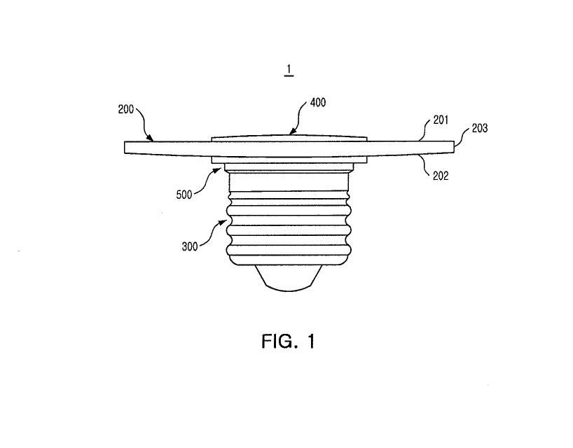

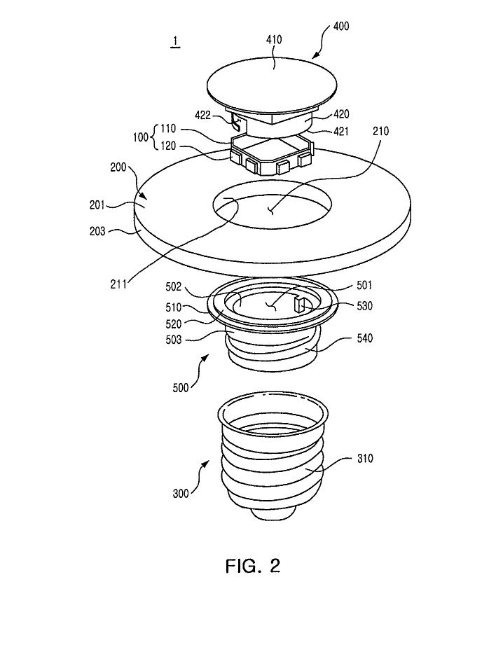

A lighting device according to an embodiment of the present inventive concepts is described with reference to FIGS. 1 and 2. FIG. 1 is a schematic side view of a lighting device according to an embodiment of the present inventive concepts, and FIG. 2 is an exploded perspective view schematically illustrating the lighting device of FIG. 1.

Referring to FIGS. 1 and 2, a lighting device 1 according to embodiment of the present inventive concepts may include a light source unit 100, a light spreading unit 200, and a base unit 300. The lighting device 1 may further include a heat dissipating unit 400 and a housing unit 500.

The light source unit 100 may be constructed and arranged to irradiate light in a radial direction. To this end, the light source unit 100 may include an annular-shaped board 110, for example a circuit board or substrate and a plurality of light emitting elements 120 mounted on the board 110 or fabricated on the board 100.

The board 110 may comprise a material having excellent heat dissipation functionality and light reflectivity. In some example embodiments, the board 110 may be an FR4-type printed circuit board (PCB), and may be made of an organic resin material containing epoxy, triazine, silicon, polyimide, or the like, and any other organic resin materials. In other embodiments, the board 110 may be made of a ceramic material such as a silicon nitride, AlN, Al₂O₃, or the like, or a metal and a metal compound, and may include an MCPCB, or the like. Also, in some embodiments, the board 110 may be modified to fit a light spreading unit having a curved shape by using a flexible PCB (FPCB) that can be freely deformed, for example that is pliable.

Hereinafter, various structures of boards that may be employed in the present embodiment will be described.

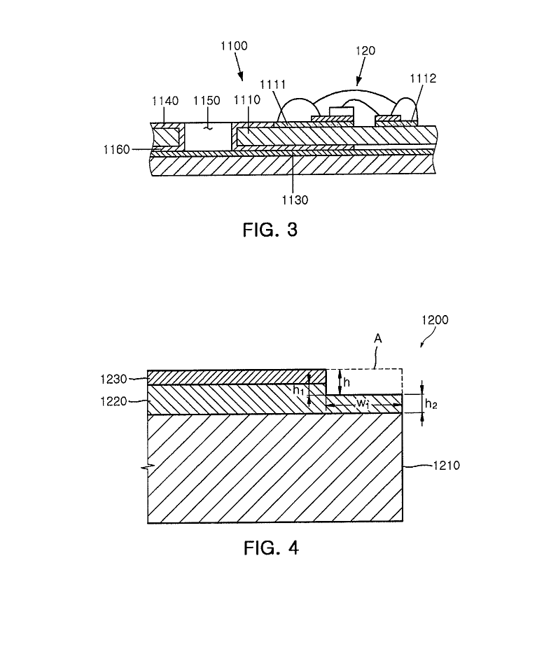

As illustrated in FIG. 3, a board 1100 may include an insulating substrate 1110 having predetermined circuit patterns 1111 and 1112 formed on one surface thereof, an upper heat diffusion plate 1140 formed on the insulating substrate 1110 such that it is in contact with the circuit patterns 1111 and 1112 and constructed and arranged to dissipate heat generated by the light emitting element 120. A lower heat diffusion plate 1160 is formed on the other surface of the insulating substrate 1110 and constructed and arranged to outwardly diffuse heat transmitted by the upper heat diffusion plate 1140. The upper heat diffusion plate 1140 and the lower heat diffusion plate 1160 may be connected by at least one through hole 1150 penetrating the insulating substrate 1110 and having a plated inner wall.

The circuit pattern 1111 and 1112 of the insulating substrate 1110 may be formed by coating copper foil on a ceramic or epoxy resin-based FR4 core and by performing an etching process thereon. An insulating thin film 1130 may be coated on a lower surface of the board 1100.

FIG. 4 illustrates another example embodiment of the board. As illustrated in FIG. 4, a board 1200 may include an insulating layer 1220 formed on a first metal layer 1210 and a second metal layer 1230 formed on the insulating layer 1220. The substrate 1200 may have a step portion ‘A’, for example, in the form of a recess, formed in at least one end portion thereof and allowing the insulating layer 1220 to be exposed.

In some embodiments, the first metal layer 1210 may be made of a material having excellent exothermic characteristics. For example, the first metal layer 1210 may be made of a metal such as aluminum (Al), iron (Fe), or the like, or an alloy, and may be formed as a single layer or as a multilayer structure. The insulating layer 1220 may be made of a material having insulating characteristics, and may, in some embodiments, be formed of an inorganic or organic material. For example, the insulating layer 1220 may be made of an epoxy-based insulating resin, and in order to enhance thermal conductivity, the insulating layer 1220 may include a metal powder such as aluminum (Al) powder, or the like, so as to be used. In some embodiments, the second metal layer 1230 may generally be formed as a copper (Cu) thin film, or other suitable conductive layer.

As illustrated in FIG. 4, in the metal board, a distance, i.e., an insulation distance, of the exposed region of one end portion of the insulating layer 1220 may be greater than a thickness of the insulating layer 1220. In the present disclosure, the insulation distance refers to a distance of the exposed region of the insulating layer 1220 between the first metal layer 1210 and the second metal layer 1230. When the metal board is viewed from above, a width of the exposed region of the insulating layer 1220 is referred to as an exposure width W₁. The region ‘A’ in FIG. 4 is a region removed by a grinding process, or the like, during a process of fabricating the metal board. An end portion of the metal board may have a depth ‘h’ corresponding to a distance from a surface of the second metal layer 1230 to the insulating layer 1220 where the insulating layer 1220 is exposed by the exposure width W₁, forming a step structure. If the end portion of the metal board is not removed, an insulation distance corresponds to a thickness (h1+h2) of the insulating layer 1220, and by removing a portion of the end portion, the insulation distance approximately corresponding to a distance W₁ may further be secured. Accordingly, in the case of conducting a withstand voltage experiment with respect to the metal board, the metal board having a structure in which contact possibility between the two metal layers 1210 and 1230 in the end portions thereof is minimized can be provided.

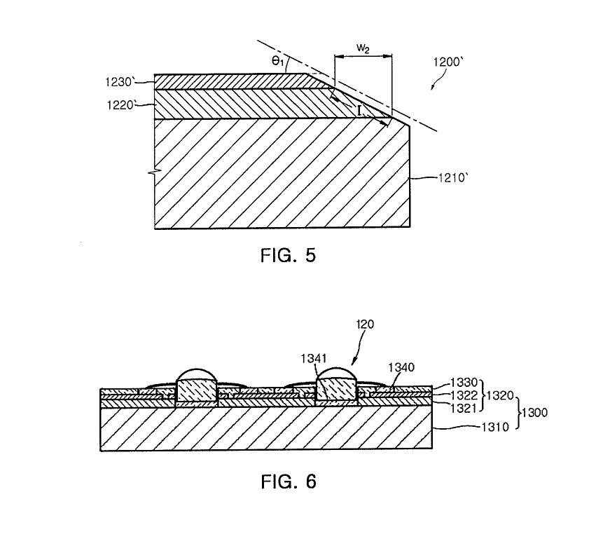

FIG. 5 schematically illustrates a structure of a metal board according to a modification of the embodiment of FIG. 4. Referring to FIG. 5, a metal board 1200′ includes an insulating layer 1220′ formed on a first metal layer 1210′ and a second metal layer 1230′ formed on the insulating layer 1220′. The insulating layer 1220′ and the second metal layer 1230′ include regions removed at a predetermined slope angle θ1, and even the first metal layer 1210′ may include a region removed at the predetermined slope angle θ1.

Here, the slope angle θ1 may be an angle between an interface between the insulating layer 1220′ and the second metal layer 1230′ and an end portion of the insulating layer 1220′, and may be selected to secure a desired insulation distance I in consideration of a thickness of the insulating layer 1220′. The slope angle θ1 may be selected within a range of 0<θ1<90 (degrees). As the slope angle θ1 is increased, the insulation distance I and a width W2 of the exposed region of the insulating layer 1220′ are increased. Thus, in order to secure a greater insulation distance, the slope angle θ1 may be selected to be small. For example, the slope angle θ1 may be selected to be within a range of 0<θ1≦45 (degrees).

FIG. 6 schematically illustrates another example embodiment of a board. Referring to FIG. 6, a board 1300 is formed by laminating a resin coated copper (RCC) film 1320, which includes an insulating layer 1321 and a copper foil 1322 laminated on the insulating layer 1321, on a metal support substrate 1310, and a portion of the RCC film 1320 may be removed to form at least one recess allowing the light emitting element 120 to be installed therein. In the metal board, since the RCC film 1320 is removed from a lower region of the light emitting element 120, the light emitting element 120 is in direct contact with the metal support substrate 1310, whereby heat generated by the light emitting element 120 is directly transmitted to the metal support substrate 1310, enhancing a heat dissipation performance thereof. The light emitting element 120 may be electrically connected or fixed to the substrate 1310 or film 1320 through soldering (solders 1340 and 1341). A protective layer 1330 made of liquefied PSR may be formed on the copper foil 1322.

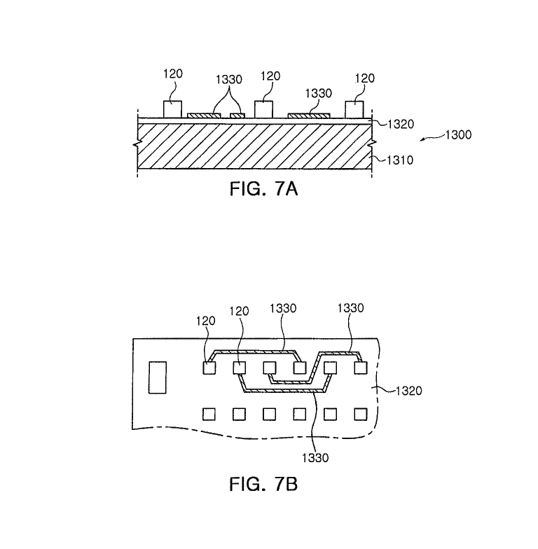

FIGS. 7a and 7b are sectional and plan views of another example of a board. In this embodiment, the board comprises an anodized metal board having excellent heat dissipation characteristics and incurring low manufacturing costs. Referring to FIG. 7, the anodized metal board 1300 may include a metal plate 1310, an anodized oxide film 1320 formed on the metal plate 1310, and electrical wirings 1330 formed on the anodized oxide film 1320.

In various embodiments, the metal plate 1310 may comprise aluminum (Al) or an aluminum alloy that may be readily obtained at relatively low cost. In some embodiments, the metal plate 1310 may comprise any other anodisable metal, for example, titanium, magnesium, or the like.

The aluminum anodized oxide film Al₂O₃ 1320 obtained by anodizing aluminum has relatively high heat transmission characteristics ranging from approximately 10 to 30 W/mK. Thus, the anodized metal board has superior heat dissipation characteristics, relative to a printed circuit board (PCB), a metal core printed circuit board (MCPCB), or the like, of a conventional polymer board.

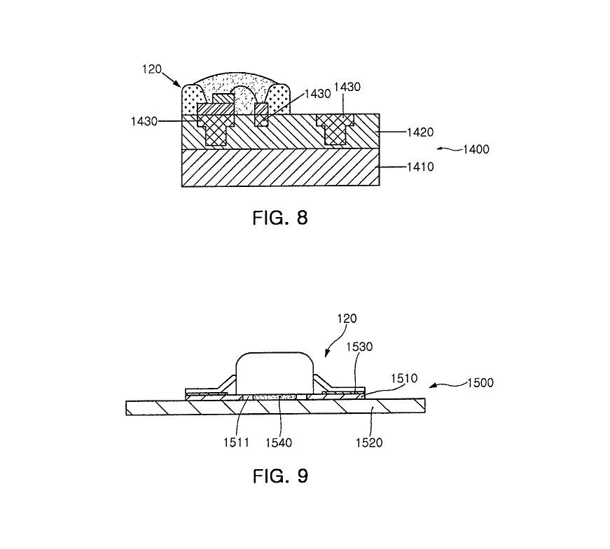

FIG. 8 schematically illustrates another example of a board. As illustrated in FIG. 8, a board 1400 may include an insulating resin 1420 coated on a metal substrate 1410 and a circuit pattern 1430 formed on the insulating resin 1420. Here, the insulating resin 1420 may have a thickness equal to or less than 200 μm. The insulating resin 1420 may be laminated as a solid film on the metal board 1410 or may be coated as a liquid according to a casting method using spin coating or a blade. Also, the circuit pattern 1430 may be formed by filling a design of a circuit pattern intagliated on the insulating resin 1420 with metal such as copper (Cu), or the like. The light emitting element 120 may be installed to be connected to the circuit pattern 1430.

In some embodiments, the board may include a flexible printed circuit board (FPCB) that is freely deformable. As illustrated in FIG. 9, a board 1500 may include an FPCB 1510 having one or more through holes 1511 and a support substrate 1520 on which the FPCB 1510 is mounted. A heat dissipation adhesive 1540 coupling a lower surface of the light emitting element 120 and an upper surface of the support substrate 1520 may be provided in the through hole 1511. Here, the lower surface of the light emitting element 120 may be a lower surface of a chip package, a lower surface of a lead frame with a chip mounted thereon, or a metal block. The FPCB 1510 includes a circuit wiring 1530, so it can be electrically connected to the light emitting element 120 thereby.

In this manner, by using the FPCB 1510, the thickness and weight of the board, and resulting device, can be reduced, and manufacturing costs can be reduced. Also, since the light emitting element 120 is directly bonded to the support substrate 1520 by the heat dissipation adhesive 1540, enhancing heat dissipation efficiency, heat generated by the light emitting element 120 can be easily dissipated.

The board 110 may have a flat plate structure having pairs of flat sides. In the present embodiments described, for example the embodiment of FIG. 2. the board 110 is illustrated to have a rectangular shape and extend in a length direction, however the present inventive concepts are not limited thereto. For example, the board 110 may have a square shape or any other polygonal shape.

As illustrated, the board 110 may have a structure in which the pairs of sides are respectively stood or otherwise constructed and arranged on edge to face one another laterally, and the sides are connected to have an annular shape. In the present embodiment of FIG. 2, the board 110 is illustrated as having a quadrangular (four-sided) annular shape, however the present inventive concepts are not limited thereto. For example, the sides of the board 110 may be connected to have a circular annular shape. Also, the sides of the board 110 may be connected to have polygonal shape such as a triangular shape, a pentagonal shape, a hexagonal shape, an octagonal shape, or the like.

The plurality of light emitting elements 120 may be mounted on the board 110 and electrically connected to one another. The plurality of light emitting elements 120 may be mounted on surfaces constituting outer surfaces, among the pairs of sides of the board 110, while having an annular shape and irradiating light in an outward radial direction.

Each of the light emitting elements 120 is a type of semiconductor device generating light having a predetermined wavelength according to external power applied thereto, and may include a light emitting diode (LED). The light emitting element 120 may emit blue light, green light, or red light according to a material contained therein, and may also emit white light.

Hereinafter, various light emitting elements that may be employed in the present embodiment will be described.

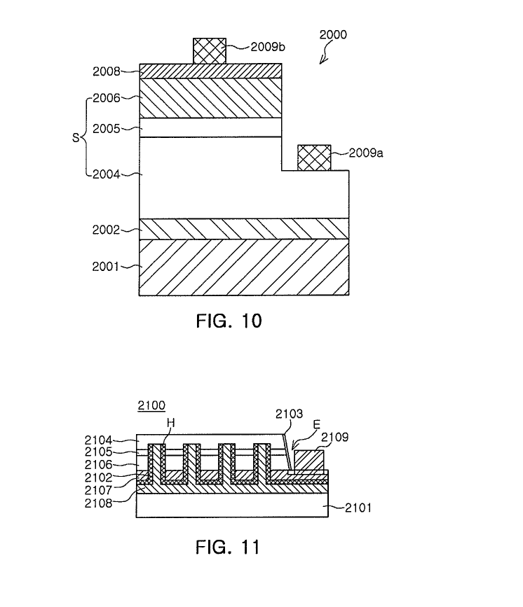

FIG. 10 is a side sectional view schematically illustrating an example of a light emitting element (e.g., a light emitting diode (LED) chip).

As illustrated in FIG. 10, a light emitting element 2000 may include a light emitting laminate S formed on a substrate 2001. The light emitting laminate S may include a first conductivity-type semiconductor layer 2004, an active layer 2005, and a second conductivity-type semiconductor layer 2006.

Also, an ohmic-contact layer 2008 may be formed on the second conductivity-type semiconductor layer 2006, and first and second electrodes 2009a and 2009b may be formed on upper surfaces of the first conductivity-type semiconductor layer 2004 and the ohmic-contact layer 2008, respectively.

In the present disclosure, terms such as ‘upper portion’, ‘upper surface’, ‘lower portion’, ‘lower surface’, ‘lateral surface’, and the like, are determined based on the drawings, and in actuality, the terms may be changed according to a direction in which a light emitting element is disposed.

Hereinafter, primary elements of a light emitting element will be described in detail.

In some embodiments, a substrate constituting a light emitting element comprises a growth substrate for epitaxial growth. As the substrate 2001, an insulating substrate, a conductive substrate, or a semiconductor substrate may be used as necessary. For example, the substrate 2001 may comprise sapphire, SiC, Si, MgAl₂O₄, MgO, LiAlO₂, LiGaO₂, GaN, or the like. In order to epitaxially grow a GaN material, a GaN substrate as a homogeneous substrate may be preferred, but a GaN substrate may incur high manufacturing costs due to difficulties in manufacturing thereof.

As a heterogeneous substrate, a sapphire substrate, a silicon carbide substrate, or the like, is commonly used, and in this case, a sapphire substrate is more frequently utilized, in favor over a relatively expensive silicon carbide substrate. In the case of using a heterogeneous substrate, a defect such as dislocation, or the like, may be increased due to a difference between lattice constants of a substrate material and a thin film material. Also, due to a difference between coefficients of thermal expansion of a substrate material and a thin film material, warping may occur in the case of a temperature change, resulting in cracks in the thin film. Such a problem may be reduced by using a buffer layer 2002 formed between the substrate 2001 and the GaN-based light emitting laminate S.

In order to enhance light or electrical characteristics of the LED chip before or after the growth of the LED structure, the substrate 2001 may be fully or partially removed or patterned during a chip fabrication process.

For example, in the case of a sapphire substrate, the substrate may be separated by irradiating a laser onto an interface between the sapphire substrate and a semiconductor layer through the substrate, and in the case of a silicon substrate or a silicon carbide substrate, the substrate may be removed according to a method such as polishing/etching, or the like.

Also, in removing the substrate, a different support substrate may be used, and in this case, the support substrate may be attached to the opposite side of the original growth substrate by using a reflective metal or a reflective structure may be inserted into a middle portion of a bonding layer to enhance light efficiency of the LED chip.

In the case of substrate patterning, depressions and protrusions (or an uneven portion) or a sloped portion is formed on a main surface (one surface or both surfaces) of the substrate or on a lateral surface before or after the growth of the LED structure to thus enhance light extraction efficiency.

Referring to substrate patterning, an uneven surface or a sloped surface may be formed on a main surface (one surface or both surfaces) or a lateral surface of the substrate to enhance light extraction efficiency. A size of the pattern may be selected from within the range of 5 nm to 500 μm, and any pattern may be employed as long as it can enhance light extraction efficiency as a regular or an irregular pattern. The pattern may have various shapes such as a columnar shape, a peaked shape, a hemispherical shape, a polygonal shape, and the like.

In the case of a sapphire substrate, sapphire is a crystal having Hexa-Rhombo R3c symmetry, of which lattice constants along the c-axis and a-axis directions are approximately 13.001 Å and 4.758 Å, respectively, and has a C-plane (0001), an A-plane (1120), an R-plane (1102), and the like. In this case, a nitride thin film may be relatively easily grown on the C-plane of the sapphire crystal, and because sapphire crystal is stable at high temperatures, the sapphire substrate is commonly used as a nitride growth substrate.

A silicon (Si) substrate may also be used. Since a silicon (Si) substrate is more appropriate for increasing a diameter and is relatively low in price, it may be used to facilitate mass-production. The Si substrate having a (111) plane as a substrate plane has a 17% difference in a lattice constant from that of GaN. Thus, a technique for suppressing a generation of a crystal defect due to the difference between lattice constants is required. Also, a difference between coefficients of thermal expansion of silicon and GaN is approximately 56%, for which, thus, a technique of suppressing warping of a wafer due to the difference between the coefficients of thermal expansion is required. A warped wafer may cause cracks in the GaN thin film and make it difficult to control processing, leading to an increase in a distribution of light emitting wavelengths in the same wafer, or the like.

The silicon (Si) substrate absorbs light generated in the GaN-based semiconductor to lower external quantum efficiency of the light emitting element. Thus, the substrate may be removed as necessary, and a support substrate such as an Si, Ge, SiAl, ceramic, or metal substrate, or the like, including a reflective layer, may be additionally formed to be used.

When a GaN thin film is grown on a heterogeneous substrate like the Si substrate, dislocation density may be increased due to a lattice constant mismatch between a substrate material and a thin film material, and cracks and warpage may be generated due to a difference between coefficients of thermal expansion.

In this case, in order to prevent dislocation of and cracks in the light emitting laminate S, a buffer layer 2002 may be disposed between the substrate 2001 and the light emitting laminate S. The buffer layer 2002 may serve to adjust a degree of warpage of the substrate when an active layer is grown, to reduce a wavelength distribution of a wafer.

The buffer layer may be made of AlxInyGa1-x-yN (O≦x≦1, 0≦y≦1), in particular, GaN, AlN, AlGaN, InGaN, or InGaNAlN, and a material such as ZrB₂, HfB₂, ZrN, HfN, TiN, or the like, may also be used as necessary. Also, the buffer layer may be formed by combining a plurality of layers or by gradually changing a composition over a plurality of layers.

The silicon substrate has a significant difference in the coefficient of thermal expansion from that of GaN. Thus, in the case of growing a GaN-based thin film on the silicon substrate, when the GaN thin film is grown at a high temperature and cooled at room temperature, tensile stress is applied to the GaN thin film due to the difference between the coefficients of thermal expansion of the substrate and the thin film, generating cracks. In order to prevent a generation of cracks, tensile stress is compensated for by using a method of growing the thin film such that compressive stress is applied to the thin film while being grown.

The difference between the lattice constants of silicon (Si) and GaN increases a possibility of a defect being generated in the silicon substrate. Thus, in the case of using a silicon substrate, a buffer layer having a composite structure may be used in order to control stress for restraining warpage as well as controlling a defect.

For example, first, an AlN layer is formed on the substrate 2001. In this case, a material not including gallium (Ga) may be used in order to prevent a reaction between silicon (Si) and gallium (Ga). As an alternative to AlN, a material such as SiC, or the like, may also be used. The AlN layer is grown at a temperature ranging from 400° C. to 1,300° C. by using an aluminum (Al) source and a nitrogen (N) source. An AlGaN intermediate layer may be inserted into the middle of GaN between the plurality of AlN layers to control stress, as necessary.

The light emitting laminate S having a multilayer structure of a Group III nitride semiconductor will be described in detail. The first and second conductivity-type semiconductor layers 2004 and 2006 may be formed of n-type and p-type impurity-doped semiconductors, respectively.

However, the present inventive concepts are not limited thereto and, conversely, the first and second conductivity-type semiconductor layers 2004 and 2006 may be formed of p-type and n-type impurity-doped semiconductors. For example, the first and second conductivity-type semiconductor layers 2004 and 2006 may comprise a Group III nitride semiconductor, e.g., a material having a composition of AlxInyGa1-x-yN (0≦x≦1, 0≦y≦+1, 0≦x+y≦1). Of course, the exemplary embodiment is not limited thereto and the first and second conductivity-type semiconductor layers 2004 and 2006 may alternatively comprise a material such as an AlGaInP-based semiconductor or an AlGaAs-based semiconductor.

Meanwhile, the first and second conductivity-type semiconductor layers 1404 and 1406 may have a unilayer structure, or, alternatively, the first and second conductivity-type semiconductor layers 2004 and 2006 may have a multilayer structure including layers having different compositions, thicknesses, and the like, as necessary. For example, the first and second conductivity-type semiconductor layers 2004 and 2006 may have a carrier injection layer for improving electron and hole injection efficiency, or may have various types of superlattice structures, respectively.

The first conductivity-type semiconductor layer 2004 may further include a current diffusion layer in a region adjacent to the active layer 2005. The current diffusion layer may have a structure in which a plurality of InₓAl_{y}Ga_{(1-x-y)}N layers having different compositions or different impurity contents are successively laminated or may have an insulating material layer partially formed therein.

The second conductivity-type semiconductor layer 2006 may further include an electron blocking layer in a region adjacent to the active layer 2005. The electron blocking layer may have a structure in which a plurality of InₓAl_{y}Ga_{(1-x-y)}N layers having different compositions are laminated or may have one or more layers including Al_{y}Ga_{(1-y)}N. The electron blocking layer has a bandgap wider than that of the active layer 2005, thus preventing electrons from being transferred over the second conductivity-type (p-type semiconductor layer.

The light emitting laminate S may be formed by using metal-organic chemical vapor deposition (MOCVD). In order to fabricate the light emitting laminate S, an organic metal compound gas (e.g., trimethyl gallium (TMG), trimethyl aluminum (TMA)) and a nitrogen-containing gas (ammonia (NH₃), or the like) can be supplied to a reaction container in which the substrate 2001 is installed as reactive gases, the substrate is maintained at a high temperature ranging from 900° C. to 1,100° C., and while a gallium nitride-based compound semiconductor is being grown, an impurity gas is supplied as necessary to laminate the gallium nitride-based compound semiconductor as an undoped n-type or p-type semiconductor. Silicon (Si) is a well known n-type impurity, and p-type impurities include zinc (Zn), cadmium (Cd), beryllium (Be), magnesium (Mg), calcium (Ca), barium (Ba), and the like. Among these, magnesium (Mg) and zinc (Zn) may primarily be used.

Also, the active layer 2005 disposed between the first and second conductivity-type semiconductor layers 2004 and 2006 may have a multi-quantum well (MQW) structure in which a quantum well layer and a quantum barrier layer are alternately laminated. For example, in the case of a nitride semiconductor, a GaN/InGaN structure may be used, or a single quantum well (SQW) structure may also be used.

The ohmic-contact layer 2008 may have a relatively high impurity concentration which offers low ohmic-contact resistance in order to lower an operating voltage of the element and thereby enhance its characteristics. The ohmic-contact layer 2008 may be formed of a GaN layer, a InGaN layer, a ZnO layer, or a graphene layer.

The first or second electrode 2009a or 2009b may comprise a material such as silver (Ag), nickel (Ni), aluminum (Al), rhodium (Rh), palladium (Pd), iridium (Ir), ruthenium (Ru), magnesium (Mg), zinc (Zn), platinum (Pt), gold (Au), or the like, and may have a structure including two or more layers such as Ni/Ag, Zn/Ag, Ni/Al, Zn/Al, Pd/Ag, Pd/Al, Ir/Ag. Ir/Au, Pt/Ag, Pt/Al, Ni/Ag/Pt, or the like.

The LED chip illustrated in FIG. 10 has a structure in which first and second electrodes 1409a and 1409b face the same surface as a light extracting surface. However, the chip may be configured to assume various other structures, such as a flipchip structure in which first and second electrodes face a surface opposite to a light extracting surface, a vertical structure in which first and second electrodes are formed on mutually opposing surfaces, a vertical and horizontal structure employing an electrode structure by forming several vias in a chip as a structure for enhancing current spreading efficiency and heat dissipation efficiency, and the like.

In the case of manufacturing a large light emitting element for high output, an LED chip illustrated in FIG. 11 promoting current spreading efficiency and heat dissipation efficiency may be provided.

As illustrated in FIG. 11, an LED chip 2100 may include a first conductivity-type semiconductor layer 2104, an active layer 2105, a second conductivity-type semiconductor layer 2106, a second electrode layer 2107, an insulating layer 2102, a first electrode layer 2108 and a substrate 2101 sequentially laminated. Here, in order to be electrically connected to the first conductivity-type semiconductor layer 2104, the first electrode layer 2108 includes one or more contact holes H extending from one surface of the first electrode layer 2108 to at least a partial region of the first conductivity-type semiconductor layer 2104 and electrically insulated from the second conductivity-type semiconductor layer 2106 and the active layer 2105. However, the first electrode layer 2108 is not an essential element in the present embodiment.

The contact hole H extends from an interface of the first electrode layer 1508, passing through the second electrode layer 2107, the second conductivity-type semiconductor layer 2106, and the active layer 2105, to the interior of the first conductivity-type semiconductor layer 2104. The contact hole H extends to at least an interface between the active layer 2105 and the first conductivity-type semiconductor layer 2104, and preferably, extends to a portion of the first conductivity-type semiconductor layer 2104. However, the contact hole H is formed for electrical connectivity and current spreading, so the purpose of the presence of the contact hole H is achieved when it is in contact with the first conductivity-type semiconductor layer 2104. Thus, it is not necessary for the contact hole H to extend to an external surface of the first conductivity-type semiconductor layer 2104.

The second electrode layer 2107 formed on the second conductivity-type semiconductor layer 2106 may be made of a material selected from among silver (Ag), nickel (Ni), aluminum (Al), rhodium (Rh), palladium (Pd), iridium (Ir), ruthenium (Ru), magnesium (Mg), zinc (Zn), platinum (Pt), gold (Au), and the like, in consideration of a light reflecting function and an ohmic-contact function with the second conductivity-type semiconductor layer 1506, and may be formed by using a process such as sputtering, deposition, or the like.

The contact hole H may have a form penetrating the second electrode layer 2107, the second conductivity-type semiconductor layer 2106, and the active layer 2105 so as to be connected to the first conductivity-type semiconductor layer 2104. The contact hole H may be formed using an etching process, e.g., inductively coupled plasma-reactive ion etching (ICP-RIE), or the like.

The insulating layer 2102 is formed to cover a side wall of the contact hole H and a surface of the second conductivity-type semiconductor layer 2106. In this case, at least a portion of the first conductivity-type semiconductor layer 2104 corresponding to the bottom of the contact hole H may be exposed. The insulating layer 2102 may be formed by depositing an insulating material such as SiO₂, SiOxNy, or SixNy.

The first electrode layer 2108 including a conductive via formed by filling a conductive material is formed within the contact hole H. Subsequently, the substrate 2101 is formed on the first electrode layer 2108. In this structure, the substrate 2101 may be electrically connected to the first conductivity-type semiconductor layer 2104 by a conductive via.

The substrate 2101 may comprise a material including any one of Au, Ni, Al, Cu, W, Si, Se, GaAs, SiAl, Ge, SiC, AlN, Al₂O₃, GaN, AlGaN and may be formed through a process such as plating, sputtering, deposition, bonding, or the like. However, the present inventive concepts are not limited thereto, and other suitable materials and processes may be used.

In order to reduce contact resistance, the amount, a shape, a pitch, a contact area with the first and second conductivity-type semiconductor layers 2104 and 2106, and the like, the shape and size of the contact hole H may be appropriately regulated. The contact holes H may be arranged to have various shapes in rows and columns to improve current flow.

An LED lighting device provides improved heat dissipation characteristics, and in terms of overall heat dissipation performance, an LED chip having a low heating value is preferably used in a lighting device. As an LED chip satisfying such requirements, an LED chip including a nano-structure therein (hereinafter, referred to as a ‘nano-LED chip’) may be used.

Such a nano-LED chip includes a recently developed core/shell type nano-LED chip, which has a low binding density to generate a relatively low degree of heat, and has increased luminous efficiency by increasing a light emitting area by utilizing nano-structures, prevents a degradation of efficiency due to polarization by obtaining a non-polar active layer, thus improving drop characteristics such that luminous efficiency is reduced as an amount of injected current is increased.

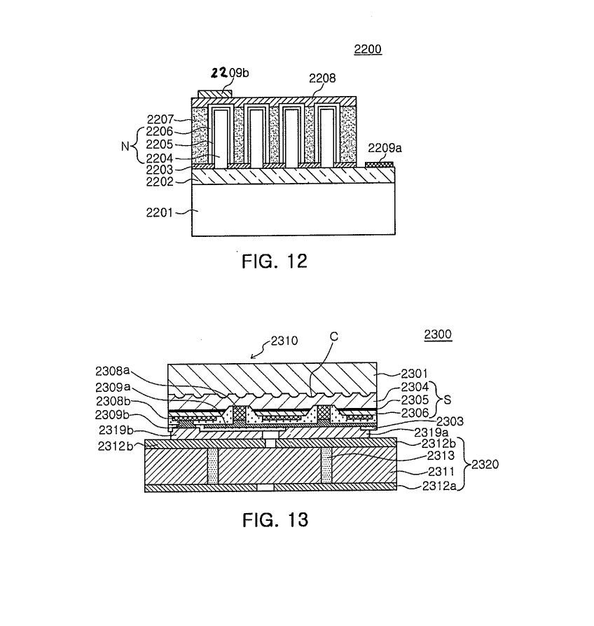

FIG. 12 illustrates a nano-LED chip as another example of an LED chip that may be employed in the foregoing lighting device.

As illustrated in FIG. 12, the nano-LED chip 2200 includes a plurality of nano-light emitting structures N formed on a substrate 2201. In this example, it is illustrated that the nano-light emitting structure N has a core-shell structure as a rod structure, but the exemplary embodiment is not limited thereto and the nano-light emitting structure N may have a different structure such as a pyramid structure.

The nano-LED chip 2200 includes a base layer 2202 formed on the substrate 2201. The base layer 2202 is a layer providing a growth surface for the nano-light emitting structure N, which may comprise a first conductivity-type semiconductor. A mask layer 2203 having an open area for the growth of the nano-light emitting structure N (in particular, the core) may be formed on the base layer 2202. The mask layer 1603 may comprise a dielectric material such as SiO₂ or SiNx.

In the nano-light emitting structure N, a first conductivity-type nano core 2204 is formed by selectively growing a first conductivity-type semiconductor by using the mask layer 1603 having an open area, and an active layer 2205 and a second conductivity-type semiconductor layer 2206 are formed as shell layers on a surface of the nano core 2204. Accordingly, the nano-light emitting structure N may have a core-shell structure in which the first conductivity-type semiconductor is a nano core and the active layer 2205 and the second conductivity-type semiconductor layer 1606 enclosing the nano core are shell layers.

The nano-LED chip 2200 includes a filler material 2207 filling spaces between the nano-light emitting structures N. The filler material 2207 may be employed as necessary in order to structurally stabilize and optically improve the nano-light emitting structures N. The filler material 2207 may comprise a transparent material such as SiO₂, but the present inventive concepts are not limited thereto. An ohmic-contact layer 2208 may be formed on the nano-light emitting structures N and connected to the second conductivity-type semiconductor layer 2206. The nano-LED chip 2200 includes the base layer 2202 formed of the first conductivity-type semiconductor and first and second electrodes 2209a and 2209b connected to the base layer 2202 and the ohmic-contact layer 1608, respectively.

By forming the nano-light emitting structures N such that they have different diameters, components, and doping densities, light having two or more different wavelengths may be emitted from the same element. By appropriately adjusting light having different wavelengths, white light may be implemented without using phosphors in the single element, and light having various desired colors or white light having different color temperatures may be implemented by combining a different LED chip to the foregoing element or combining wavelength conversion materials such as phosphors.

FIG. 13 illustrates a semiconductor light emitting element 2300 having an LED chip 2310 mounted on a mounting substrate 2320, as a light source that may be employed in the foregoing lighting device.

The semiconductor light emitting element 2300 illustrated in FIG. 13 includes the LED chip 2310. The LED chip 2310 is presented as an LED chip different from that of the example described above.

The LED chip 2310 includes a light emitting laminate S disposed on one surface of the substrate 2301 and first and second electrodes 2308a and 2308b disposed on the opposite side of the substrate 2301 relative to the light emitting laminate S. Also, the LED chip 2310 includes an insulating layer 2303 covering the first and second electrodes 2308a and 2308b.

The first and second electrodes 2308a and 2308b may be electrically connected to first and second electrode pads 2319a and 2319b connected thereto by electrical connection units 2309a and 2309b.

The light emitting laminate S may include a first conductivity-type semiconductor layer 2304, an active layer 2305, and a second conductivity-type semiconductor layer 2306 sequentially disposed on the substrate 2301. The first electrode 2308a may be provided as a conductive via connected to the first conductivity-type semiconductor layer 2304 through the second conductivity-type semiconductor layer 2306 and the active layer 2305. The second electrode 2308b may be connected to the second conductivity-type semiconductor layer 2306.

The insulating layer 2303 has an open area exposing at least portions of the first and second electrodes 2308a and 2308b, and the first and second electrode pads 2319a and 2319b may be connected to the first and second electrodes 2308a and 2308b.

The first and second electrodes 2308a and 2308b may have a multilayer structure in which one or a plurality of layers made of a conductive material having improved ohmic characteristics with respect to the first conductivity-type semiconductor layers 2304 and 2306, respectively, are formed. For example, the first and second electrodes 2308a and 2308b may be formed by depositing or sputtering one or more of silver (Ag), aluminum (Al), nickel (Ni), chromium (Cr), a transparent conductive oxide (TCO), and the like. The first and second electrodes 2308a and 2308b may be disposed in the same direction and may be mounted as a so-called flip-chip on a lead frame as described hereinafter. In this case, the first and second electrodes 2308a and 2308b may be disposed to face in the same direction.

In particular, the first electrode 2308a may be connected to the first electrical connection unit 2309a by a conductive via connected to the first conductivity-type semiconductor layer 2304 through the second conductivity-type semiconductor layer 2304 and the active layer 2305 within the light emitting laminate S.

The amount of contact area, or the shape or pitch of the contact area with the first conductivity-type semiconductor layer 2304, and the like, of the conductive via V and the first electrical connection unit 2309a may be appropriately regulated in order to lower contact resistance, and the conductive via V and the first electrical connection unit 2309a may be arranged in a row and in a column to improve current flow.

Another electrode structure may include the second electrode 2308b directly formed on the second conductivity-type semiconductor layer 2306 and the second electrical connection unit 2309b formed on the second electrode 2308b. In addition to having a function of forming electrical-ohmic connection with the second conductivity-type semiconductor layer 2306, the second electrode 2308b may be made of a light reflective material, whereby, as illustrated in FIG. 13, in a state in which the LED chip 2310 is mounted as a so-called flip chip structure, light emitted from the active layer 2305 can be effectively emitted in a direction of the substrate 2301. Of course, the second electrode 2308b may be made of a light-transmissive conductive material such as a transparent conductive oxide, according to a main light emitting direction.

The two electrode structures as described above may be electrically separated by the insulating layer 2303. The insulating layer 2303 may comprise any suitable material having electrically insulating properties. Namely, the insulating layer 2303 may be made of any material having electrically insulating properties, and here, preferably, a material having a low degree of light absorption is used. For example, a silicon oxide or a silicon nitride such as SiO₂, SiOxNy, SixNy, or the like, may be used. If necessary, a light reflective filler may be dispersed in the light-transmissive material to form a light reflective structure.

The first and second electrode pads 2319a and 2319b may be connected to the first and second electrical connection units 2309a and 2309b to serve as external terminals of the LED chip 2310, respectively. For example, the first and second electrode pads 2319a and 2319b may be made of gold (Au), silver (Ag), aluminum (Al), titanium (Ti), tungsten (W), copper (Cu), tin (Sn), nickel (Ni), platinum (Pt), chromium (Cr), NiSn, TiW, AuSn, or a eutectic metal thereof. In this case, when the LED chip 2310 is mounted on the mounting substrate 2320, the first and second electrode pads 2319a and 2319b may be bonded by using the eutectic metal, so solder bumps generally required for flip chip bonding may not be used. The use of a eutectic metal advantageously obtains superior heat dissipation effects in the mounting method as compared to the case of using solder bumps. In this case, in order to obtain excellent heat dissipation effects, the first and second electrode pads 2319a and 2319b may be formed to occupy a relatively large area.

The substrate 2301 and the light emitting laminate S may be understood with reference to content described above with reference to FIG. 10 unless otherwise described. Also, although not shown, a buffer layer may be formed between the light emitting laminate S and the substrate 2301. The buffer layer may be employed as an undoped semiconductor layer made of a nitride, or the like, to alleviate lattice defects of the light emitting laminate S grown thereon.

The substrate 2301 may have first and second main surfaces opposing one another, and an uneven structure C (i.e., depressions and protrusions) may be formed on at least one of the first and second main surfaces. The uneven structure C formed on one surface of the substrate 2301 may be formed by etching a portion of the substrate 2301 so as to be made of the same material as that of the substrate. Alternatively, the uneven structure C may comprise a heterogeneous material different from that of the substrate 2301.

In the exemplary embodiment, since the uneven structure C is formed on the interface between the substrate 2301 and the first conductivity-type semiconductor layer 2304, the paths of light emitted from the active layer 2305 may be widely varied, and thus, a light absorption ratio of light absorbed within the semiconductor layer can be reduced and a light scattering ratio can be increased, increasing light extraction efficiency.

In detail, the uneven structure C may be formed to have a regular or irregular shape. The heterogeneous material used to form the uneven structure C may be a transparent conductor, a transparent insulator, or a material having excellent reflectivity. Here, as the transparent insulator, a material such as SiO₂, SiNx, Al₂O₃, HfO, TiO₂, or ZrO may be used. As the transparent conductor, a transparent conductive oxide (TCO) such as ZnO, an indium oxide containing an additive (e.g., Mg, Ag, Zn, Sc, Hf, Zr, Te, Se, Ta, W, Nb, Cu, Si, Ni, Co, Mo, Cr, Sn), or the like, may be used. As the reflective material, silver (Ag), aluminum (Al), or a distributed Bragg reflector (DBR) including multiple layers having different refractive indices, may be used. However, the exemplary embodiment is not limited thereto.

The substrate 2301 may be removed from the first conductivity-type semiconductor layer 2304. To remove the substrate 2301, a laser lift-off (LLO) process using a laser, an etching or a polishing process may be used. Also, after the substrate 2301 is removed, depressions and protrusions may be formed on the surface of the first conductivity-type semiconductor layer 2304.

As illustrated in FIG. 13, the LED chip 2310 is mounted on the mounting substrate 2320. The mounting substrate 2320 includes a first upper electrode layer 2312a, a first lower electrode layer 2312b, a second upper electrode layer 2313a and a second lower electrode layer 2313b formed on upper and lower surfaces of the substrate body 2311, and vias 2313 penetrating the substrate body 2311 to connect the upper and lower electrode layers. The substrate body 2311 may comprise a resin, a ceramic, or a metal, and the upper and lower electrode layers 2312a, 2313a, 2312b and 2313b may comprise a metal layer made of gold (Au), copper (Cu), silver (Ag), or aluminum (Al).

The substrate on which the foregoing LED chip 2310 is mounted is not limited to the configuration of the mounting substrate 2320 illustrated in FIG. 13, and any suitable substrate having a wiring structure for driving the LED chip 2310 may be employed. For example, the substrate described above with reference to FIGS. 3 through 9 may be applicable.

Besides the foregoing LED chips, LED chips having various other structures may also be used. For example, an LED chip in which surface-plasmon polaritons (SPP) are formed in a metal-dielectric boundary of an LED chip to interact with quantum well excitons, thus obtaining significantly improved light extraction efficiency, may also be advantageously used.

Various types of LED chips may be mounted as bare chips on a circuit board and used as a light source of a lighting device, and differently, various types of package structures in which an LED chip is mounted in a package body having a pair of electrode structures may also be used.

A package including an LED chip (hereinafter, referred to as an ‘LED package’) may provide an external terminal structure facilitating a connection to an external circuit and may have various optical structures having a heat dissipation structure improving heat dissipation characteristics of the LED chip and enhancing emitted light characteristics. For example, the various optical structures may include a lens structure for improving light distribution characteristics or a wavelength conversion unit for converting light emitted from the LED chip into light having a different wavelength.

As an example of an LED package that may be employed in a lighting device, an LED chip package having a chip scale package (CSP) structure may be used.

The CSP, reducing a size of the LED chip package and simplifying a manufacturing process, is appropriate for mass-production, and since a wavelength conversion material such as a phosphor and an optical structure such as a lens can be integrally fabricated together with an LED chip by the CSP, the CSP can be appropriately used in a lighting device.

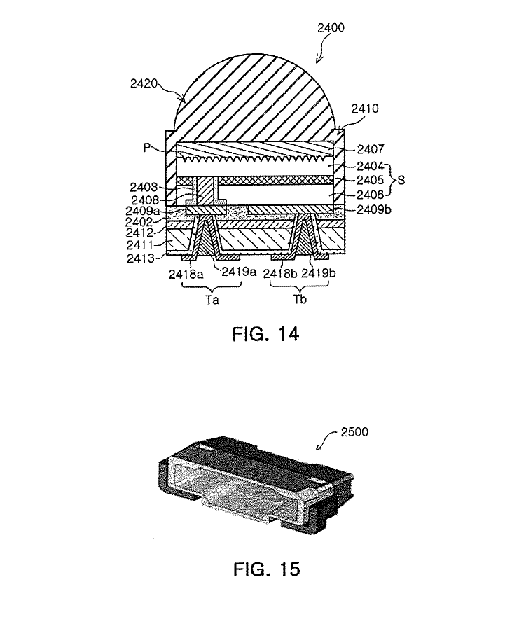

FIG. 14 illustrates an example of a CSP, a package structure in which an electrode is formed on a lower surface of an LED chip 2410, opposite to a main light extracting surface, and a phosphor layer 2407 and a lens 2420 are integrally formed.

The SCP 2400 illustrated in FIG. 14 includes a light emitting laminate S disposed on a mounting substrate 2411, first and second terminal units Ta and Tb, the phosphor layer 2407, and the lens 2420.

The light emitting laminate S is a lamination structure including first and second conductivity-type semiconductor layers 2404 and 2406 and an active layer 2405 disposed therebetween. In the present embodiment, the first and second conductivity-type semiconductor layers 2404 and 2406 may be n-type and an p-type semiconductor layers, respectively, and may, in some embodiments, comprise a nitride semiconductor, e.g., AlₓIn_{y}Ga_{(1-x-y)}N (0≦x≦1, 0≦y≦1, 0≦x+y≦1). However, besides a nitride semiconductor, a GaAs-based semiconductor or GaP-based semiconductor may also be used.

The active layer 2405 formed between the first and second conductivity-type semiconductor layers 2404 and 2406 may emit light having a predetermined level of energy according to electron-hole recombination, and may have a multi-quantum well (MQW) structure in which a quantum well layer and a quantum barrier layer are alternately laminated. In the case of the MQW structure, for example, an InGaN/GaN or AlGaN/GaN structure may be used.

Meanwhile, the first and second conductivity-type semiconductor layers 2404 and 2406 and the active layer 1805 may be formed by using a semiconductor growth process such as metal-organic chemical vapor deposition (MOCVD), molecular beam epitaxy (MBE), hydride vapor phase epitaxy (HVPE), or the like.

The LED 2410 illustrated in FIG. 14 is in a state in which a growth substrate was removed, and depressions and protrusions (or an uneven surface) P may be formed on the surface from which the growth substrate was removed. Also, the phosphor layer 2407 may be applied to the uneven surface, as a light conversion layer.

The LED 2410 includes first and second electrodes 2409a and 2409b connected to the first and second conductivity-type semiconductor layers 2404 and 2406, respectively. The first electrode 2409a may have a conductive via 2408 connected to the first conductivity-type semiconductor layer 2404 through the second conductivity-type semiconductor layer 2406 and the active layer 2405. An insulating layer 2403 is formed between the active layer 2405 and the second conductivity-type semiconductor layer 1806 in the conductive via 2408 to prevent an occurrence of short-circuits.

A single conductive via 1808 is illustrated, but two or more conductive vias 2408 may be provided to advantageously distribute current, and may be arranged in various forms.

The mounting substrate 2411 employed in the present embodiment is illustrated as a support substrate such as a silicon substrate to which a semiconductor process can be easily applicable, but the present inventive concepts are not limited thereto. The mounting substrate 2411 and the LED chip 2410 may be bonded by first and second bonding layers 2402 and 2412. The first and second bonding layers 2402 and 2412 may be made of an electrically insulating material or an electrically conductive material. For example, the electrically insulating material may include an oxide such as SiO₂, SiN, or the like, a resin material such as a silicon resin, an epoxy resin, or the like. The electrically conductive material may include silver (Ag), aluminum (Al), titanium (Ti), tungsten (W), copper (Cu), tin (Sn), nickel (Ni), platinum (Pt), chromium (Cr), NiSn, TiW, AuSn, or a eutectic metal alloy thereof. This process may be implemented such that the first and second bonding layers 2402 and 2412 are applied to respective bonding surfaces of the LED chip 2410 and the mounting substrate 2411 and subsequently bonded thereto.

A via is formed from a lower surface of the mounting substrate 2411 so as to be connected to the first and second electrodes 2409a and 2409b of the LED chip 2410 as bonded. An insulator 2413 may be formed on a lateral surface of the via and on a lower surface of the mounting substrate 2411. In a case in which the mounting substrate 2411 is a silicon substrate, the insulator 2413 may be provided as a silicon oxide film through thermal oxidation. The vias are filled with a conductive material to form first and second terminal units Ta and Tb connected to the first and second electrodes 2409a and 2409b. The first and second terminal units Ta and Tb may include seed layers 2418a and 2418b and plating charged units 2419a and 2419b formed through a plating process by using the seed layers 2418a and 2418b.

As another example, as illustrated in FIG. 15, a side view package having a structure in which an LED chip is stood vertically with respect to the substrate 110 may be used. In this case, the LED chip may irradiate light onto a lateral surface with respect to the mounting surface of the substrate, and a heat dissipation effect through the substrate can be enhanced.

The light emitting element 120 may be configured to include at least one of a light emitting element emitting white light by combining green, red, and orange phosphors with a blue LED chip and a purple, blue, green, red, and infrared light emitting element. In this case, the light source apparatus may have a color rendering index (CRI) adjusted to range from a natrium (Na) lamp to a sunlight level, or the like, and have a color temperature ranging from candlelight (1500K) to a blue sky (12000K) level to generate various types of white light. If necessary, the light source apparatus may generate visible light having purple, blue, green, red, orange colors, or infrared light to adjust an illumination color according to a surrounding atmosphere or mood. Also, the light source apparatus may generate light having a special wavelength stimulating plant growth.

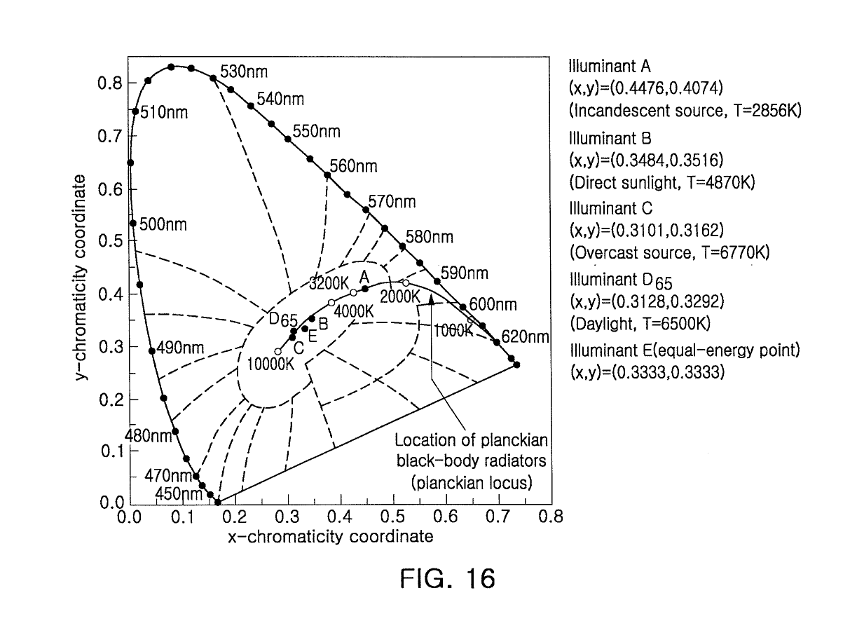

Referring to the chart of FIG. 16, white light generated by combining yellow, green, red phosphors and/or green and red LED chips and a red LED chip may have two or more peak wavelengths and may be positioned in a segment linking (x,y) coordinates (0.4476, 0.4074), (0.3484, 0.3516), (0.3101, 0.3162), (0.3128, 0.3292), (0.3333, 0.3333) of a CIE 1931 chromaticity diagram. Alternatively, white light may be positioned in a region surrounded by a spectrum of black body radiation and the segment. A color temperature of white light corresponds to a range from 2000K to 20000K.

In some embodiments, phosphors may have the following empirical formula and colors.

Oxide system: Yellow and green Y3Al5O12:Ce, Tb3Al5O12:Ce, Lu3A5O12:Ce

Silicate system: Yellow and green (Ba,Sr)2SiO4:Eu, yellow and orange (Ba,Sr)3SiO5:Ce

Nitride system: Green β-SiAlON:Eu, yellow L3Si6O11:Ce, orange α-SiAlON:Eu, red CaAlSiN3:Eu, Sr2Si5N8:Eu, SrSiAl4N7:Eu

Phosphor compositions should be basically conformed with Stoichiometry, and respective elements may be substituted with different elements of respective groups of the periodic table. For example, strontium (Sr) may be substituted with barium (Ba), calcium (Ca), magnesium (Mg), or the like, of alkali earths, and yttrium (Y) may be substituted with terbium (Tb), Lutetium (Lu), scandium (Sc), gadolinium (Gd), or the like. Also, europium (Eu), an activator, may be substituted with cerium (Ce), terbium (Tb), praseodymium (Pr), erbium (Er), ytterbium (Yb), or the like, according to a desired energy level, and an activator may be applied alone or a coactivator, or the like, may be additionally applied to change light characteristics.

Also, materials such as quantum dots, or the like, may be applied as materials that replace phosphors, and phosphors and quantum dots may be used in combination or alone in an LED.

A quantum dot may have a structure including a core (3 to 10 nm) such as CdSe, InP, or the like, a shell (0.5 to 2 nm) such as ZnS, ZnSe, or the like, and a ligand for stabilizing the core and the shell, and may implement various colors according to sizes.

Table 1 below shows types of phosphors according to application fields of a white light emitting element using a blue LED (440 nm to 460 nm).

TABLE 1

| Purpose | Phosphor |
|---|---|
| LED TV BLU | β-SiAlON: Eu2+ |
| | (Ca, Sr)AlSiN3: Eu2+ |
| | L3Si6O11: Ce3+ |
| Illumination | Lu3Al5O12: Ce3+ |
| | Ca-α-SiAlON: Eu2+ |
| | L3Si6N11: Ce3+ |
| | (Ca, Sr)AlSiN3: Eu2+ |
| | Y3Al5O12: Ce3+ |
| Wide Viewing Angle | Lu3Al5O12: Ce3+ |
| (Mobile Notebook PC) | Ca-α-SiAlON: Eu2+ |
| | L3Si6N11: Ce3+ |
| | (Ca, Sr)AlSiN3: Eu2+ |
| | Y3Al5O12: Ce3+ |
| | (Sr, Ba, Ca, Mg)2SiO4: Eu2+ |
| Electrical component | Lu3Al5O12: Ce3+ |
| (Head Lamp, etc.) | Ca-α-SiAlON: Eu2+ |
| | L3Si6N11: Ce3+ |
| | (Ca, Sr)AlSiN3: Eu2+ |
| | Y3Al5O12: Ce3+ |

Phosphors or quantum dots may be applied by using at least one of a method of spraying them on a light emitting element, a method of covering as a film, and a method of attaching as a sheet of ceramic phosphor, or the like.

As the spraying method, dispensing, spray coating, or the like, is generally used, and dispensing includes a pneumatic method and a mechanical method such as a screw fastening scheme, a linear type fastening scheme, or the like. Through a jetting method, an amount of dotting may be controlled through a very small amount of discharging and color coordinates (or chromaticity) may be controlled therethrough. In the case of a method of collectively applying phosphors on a wafer level or on a mounting board on which an LED is mounted, productivity can be enhanced and a thickness can be easily controlled.

The method of covering phosphors or quantum dots as a film on a light emitting element may include electrophoresis, screen printing, or a phosphor molding method, and these methods may have a difference according to whether a lateral surface of a chip is required to be coated or not.

Meanwhile, in order to control efficiency of a long wavelength light emitting phosphor re-absorbing light emitted in a short wavelength, among two types of phosphors having different light emitting wavelengths, two types of phosphor layer having different light emitting wavelengths may be provided, and in order to minimize re-absorption and interference of chips and two or more wavelengths, a DBR (ODR) layer may be included between respective layers. In order to form a uniformly coated film, after a phosphor is fabricated as a film or a ceramic form and attached to a chip or a light emitting element.

In order to differentiate light efficiency and light distribution characteristics, a light conversion material may be positioned in a remote form, and in this case, the light conversion material may be positioned together with a material such as a light-transmissive polymer, glass, or the like, according to durability and heat resistance.

A phosphor applying technique plays the most important role in determining light characteristics in an LED device, so techniques of controlling a thickness of a phosphor application layer, a uniform phosphor distribution, and the like, have been variously researched.

A quantum dot (QD) may also be positioned in a light emitting element in the same manner as that of a phosphor, and may be positioned in glass or a light-transmissive polymer material to perform optical conversion.

Meanwhile, in order to protect a light emitting element from an external environment or in order to improve light extraction efficiency of light emitted to the outside of a light emitting element, a light-transmissive material may be positioned on the light emitting element as a filler. In this case, a transparent organic solvent such as epoxy, silicon, a hybrid of epoxy and silicon, or the like, is applied as a light-transmissive material, and the light-transmissive material may be cured according to heating, light irradiation, a time-lapse method, or the like.

In the case of silicon, polydimethyl siloxane is classified as a methyl-based silicon and polymethylphenyl siloxane is classified as a phenyl-based silicon. The methyl-based silicon and the phenyl-based silicon have differences in refractive indexes, water vapor transmission rates, light transmittance amounts, light fastness qualities, and thermostability. Also, the methyl-based silicon and the phenyl-based silicon have differences in curing speeds according to a cross linker and a catalyst, affecting phosphor distribution.

Light extraction efficiency varies according to a refractive index of a filler, and in order to minimize a gap between a refractive index of the outermost medium of a chip of a portion from which blue light is emitted and a refractive index of a portion emitted by air, two or more types of silicon having different refractive indices may be sequentially laminated.

In general, methyl-based silicon has the highest level of thermostability, and variations in a temperature increase are reduced in order of phenyl-based silicon, hybrid silicon, and epoxy silicon. Silicon may be classified as a gel-type silicon, an elastomer-type silicon, and a resin-type silicon according to the degree of hardness thereof.

Also, the light emitting element may further include a lens for radially guiding light emitted from a light source. In this case, a previously formed lens may be attached to a light emitting element according to a lens attachment method, or an organic solvent having fluidity may be injected into a mold with a light emitting element mounted therein and solidified.

The lens attachment method includes directly attaching a lens to a filler, bonding only an upper portion of a chip or an outer portion of a light emitting element or an outer portion of the lens, spaced apart from the filler, and the like. As the method of injecting into a mold, injection molding, transfer molding, compression molding, or the like, may be used.

Light transmission characteristics may be changed according to shapes of lenses (concave, convex, uneven, conical, and geometrical structures), and lenses may be modified according to efficiency and light distribution characteristics.

In the present embodiment, the light emitting element 120 is illustrated as being a single package unit including an LED chip therein, but the present inventive concepts are not limited thereto. For example, the light emitting element 120 may be an LED chip itself. In this case, the LED chip may be a COB type chip and may be mounted on the board 110 and directly electrically connected to the board 110 through a flip chip bonding method or a wire bonding method.

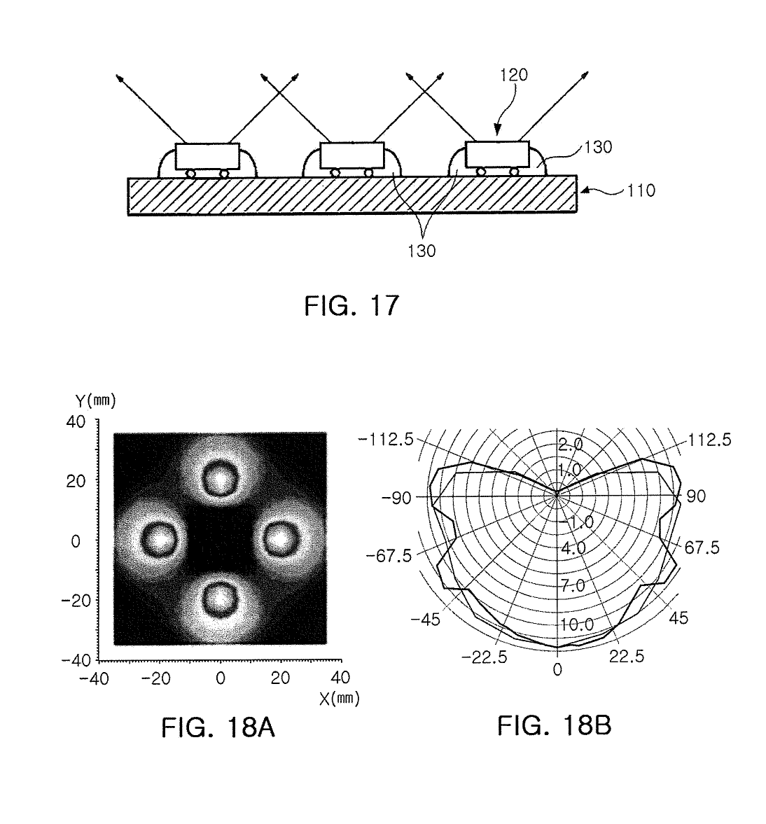

Also, as illustrated in FIG. 17, a waterproof agent 130 may be formed between the board 110 and the light emitting element 120 to surround the ambient regions of the light emitting element 120.

A plurality of light emitting elements 120 may be arranged on the board 110 having an annular shape. In this case, the light emitting elements 120 may be a same type of light emitting elements generating light having the same wavelength or may be various types of light emitting elements generating different wavelengths of light.

In the present embodiment, it is illustrated that the plurality of light emitting elements 120 are arranged such that they are spaced apart from one another by a predetermined interval to form a single line, but the present inventive concepts are not limited thereto. For example, the plurality of light emitting elements 120 may be arranged to form a plurality of lines. For example the light emitting elements may be formed in rows and columns in a two-dimensional array on each board.

Returning to FIGS. 1 and 2, the light spreading unit 200 guides light irradiated from the light source unit 100 in a radial direction to allow light to be emitted outwardly. Namely, the light spreading unit 200 corresponds to a type of light guide member and serves to allow outwardly emitted light to be irradiated laterally and even backwardly, as well as forwardly, thus expanding light distribution regions of the device.

The light spreading unit 200 may comprise a material having transparency and heat conduction characteristics to allow light emitted from the light source unit 100 to be transmitted therethrough and irradiated outwardly. For example, the material may include polycarbonate (PC), polymethylmethacrylate (PMMA), thermally conductive plastic, and the like. Also, the light spreading unit 200 may be made of a glass material but the present inventive concepts are not limited thereto. In order to allow internally incident light to be guided and spread in a manner similar to that of a light guide member, the light spreading unit 200 may have a solid structure.

The light spreading unit 200 may include an upper surface 201, a lower surface 202, and an outer surface 203 connecting the upper surface 201 and the lower surface 202 and may have an overall thin plate structure. In this case, the thickness defined by the upper surface 201 and the lower surface 202 of the light spreading unit 200 may correspond to the thickness of the light source unit 100. Namely, the light spreading unit 200 may have a thickness corresponding to a height of the vertically positioned board 110. Accordingly, the thickness of the resulting lighting device 1 overall can be reduced.

In the present disclosure, terms such as ‘upper portion’, ‘lower portion’, ‘upper surface’, ‘lower surface’, ‘lateral surface’, and the like, are determined based on the drawings, and in actuality, the terms may be changed according to a direction in which the lighting device 1 is disposed.

In some embodiments, the upper surface 201 may be planar, and the lower surface 202 may be curved. In detail, the lower surface 202 may be a gently curved to be sloped toward the upper surface 201 in a region adjacent to the outer surface 203. Thus, a thickness of the light spreading unit 200 may be decreased in a direction toward its edges 203 from the center thereof.

In the present embodiment, it is illustrated that the lower surface 202 is curved, rather than being planar, however the present inventive concepts are not limited thereto. For example, the lower surface 202 may be planar like the upper surface 201. Thus, the lower surface 202 may form a surface flatly sloped with a gentle slope toward the upper surface 201. Alternatively, the lower surface 202 may be parallel to the upper surface 201. In this case, the light spreading unit 200 may have a structure in which a thickness thereof is constant overall. Alternatively, the upper surface 201 may be curved and the lower surface 202 planar, or both upper 201 and lower 202 surfaces may be curved.

In various embodiments, a concavo-convex pattern may be formed on at least some of the ‘upper portion, ‘lower power’, ‘upper surface’, ‘lower surface’, and ‘lateral surface’ of the light spreading unit 200.

An accommodation hole 210 may be formed to integrally penetrate the upper surface 201 and the lower surface 202 in the center thereof. The upper surface 201 and the lower surface 202 radially extend from the accommodation hole 210 to the outer surface 203 spaced apart from the accommodation hole 210 by a predetermined distance. Thus, the light spreading unit 200 may have an overall thin donut-like plate structure in which the accommodation hole 210 penetrates the center thereof. The light source unit 100 may be accommodated and disposed within the accommodation hole 210.

The base unit 300 is provided on the lower surface 202 of the light spreading unit 200 to supply power to the light source unit 100. The base unit 300 corresponds to a type of terminal and may be detachably fastened to a socket provided in a fixed implement in a ceiling, a wall, or the like, and electrically connected thereto.

The base unit 300 may be made of a material having electrical conductivity, for example, a metal. In the present embodiment, the base unit 300 is illustrated as having an Edison type structure having a screw-fastening type thread, however, the present inventive concepts are not limited thereto. For example, the base unit 300 may have a rail type structure or a slide contact type structure. Also, the base unit 300 may have a USB socket type structure or an adapter socket type structure. In this case, a material of the base unit 300 may be appropriately changed according to a corresponding type structure.

Meanwhile, the heat dissipating unit 400 supports the light source unit 100 such that the light source unit 100 is positioned within the accommodation hole 210, and dissipates heat generated by the light source unit 100. The heat dissipating unit 400 may comprise a material having excellent heat conductivity to easily dissipate heat. For example, the heat dissipating unit 400 may be made of metal, ceramics, or plastic. However, the present inventive concepts are not limited thereto and the heat dissipating unit 400 may be made of any other material having high heat conductivity.

The heat dissipating unit 400 may include a cover 410 covering the accommodation hole 210 opened upwardly from the upper surface 201 of the light spreading unit 200 and a body 420 extending from a lower surface of the cover 410 and inserted into the accommodation hole 210.

The cover 410 may have a shape corresponding to that of the accommodation hole 210, such that the accommodation hole 210 is not exposed when covered by the cover 410.

The body 420 may have a sectional area having a size less than that of the accommodation hole 210 so as to be inserted into the accommodation hole 210. An end surface 421 of the body 420 extends from the lower surface of the cover 410. The end surface 421 may have a thickness greater than that of the light spreading unit 200 such that it can be protruded outwardly from the lower surface 202 of the light spreading unit 200 through the accommodation hole 210.

The light source unit 100 may be fixedly attached to an outer surface of the body 420. Thus, a portion of the body 420, to which the light source unit 100 is attached, may have a sectional structure corresponding to the annular shape of the board 110 of the light source unit 100. For example, when the board 110 has a quadrangular annular shape, the body 420 may also have a quadrangular section. Thus, the board 110 may be attached to an outer surface of the body 420.

Of course, the annular shape of the board 110 may be changed to correspond to the sectional structure of the body 420. The sectional structure of the body 420 may be variously modified according to a sectional structure of the accommodation hole 210.

The heat dissipating unit 400 may serve as a support member supporting the light source unit 100 and as a heat sink member dissipating heat from the light source unit 100. In detail, the light source unit 100 may be fixedly attached to the outer surface of the body 420, and may be insertedly disposed in the accommodation hole 210 together with the body 420. In this case, the light emitting element 120 of the light source unit 100 may be positioned to face an inner surface 211 of the accommodation hole 210.

With the body 420 inserted within the accommodation hole 210, the cover 410 may cover the accommodation hole 210 and be exposed from the upper surface 201 of the light spreading unit 200. Thus, heat generated by the light source unit 100 may be transmitted to the cover 410 through the body unit 420 so as to be dissipated outwardly.

The housing unit 500 may be provided under the lower surface 202 of the light spreading unit 200 in order to cover the accommodation hole 210 opened from the lower surface 202 of the light spreading unit 200. The heat dissipating unit 400 is fastened to one surface of the housing unit 500 and the base unit 300 may be fastened to the other surface of the housing unit 500.

The housing unit 500 may have a hollow structure in which an opening 501 is formed on one surface thereof in contact with the lower surface 202 of the light spreading unit 200, and may be fabricated through a method such as injection molding, or the like, by using, for example, a resin material.

A flange 510 may be formed on the one surface of the housing unit 500 and protruded along the circumference of the housing unit 500. A step 520 may be formed in the flange 510 along the circumference of the opening 501 and inserted into the accommodation hole 210 so as to be in contact with the inner surface 211 of the accommodation hole 210.

The end surface 421 of the body 420 of the heat dissipating unit 400 may be arranged to protrude outwardly from the lower surface 202 of the light spreading unit 200, passing through the accommodation hole 210, and may be inserted into an inner surface 502 of the housing unit 500 and detachably fastened thereto. In detail, the inner surface 502 may have a first fastening unit 530 formed thereon, and the first fastening unit 530 may include, for example, a stopping protrusion. The body 420 may have a fixing recess 422 formed to correspond to the stopping protrusion. The fixing recess 422 may extend from the end surface 421 of the body 420 toward the cover 410 and be bent, having an “┐”-like shape. Thus, in a state in which the fixing recess 422 and the first fastening unit 530 are engaged, the heat dissipating unit 400 may be inserted into the accommodation hole 210 and rotated, whereby the heat dissipating unit 400 may be fastened to the housing unit 500.

In the present embodiment, it is illustrated that the stopping protrusion is formed as the first fastening unit 530 on the inner surface 502 of the housing unit 500 in order to allow the heat dissipating unit 400 to be fastened to the housing unit 500; however the present inventive concepts are not limited thereto. For example, the first fastening unit 530 may include a thread. In this case, the body 420 may have a thread corresponding to that of the first fastening unit 530, and in this case, the heat dissipating unit 400 and the housing unit 500 may be fastened such that they are detachable in a screw-fastening manner.

The outer surface 503 of the housing unit 500 may include a second fastening unit 540 formed thereon and detachably fastened to the base unit 300. The second fastening unit 540 may include a thread. Thus, the housing unit 500 and the base unit 300 may be detachably fastened in a screw-fastening manner through a thread formed on the base unit 300 and the thread of the second fastening unit 540. In the present embodiment, the other surface of the housing unit 500 may be understood as the external surface 503 of the housing unit 500.

In the present embodiment, it is illustrated that the thread is formed as the second fastening unit 540 on the outer surface of the housing unit 500 in order to be fastened to the base unit 300, but the present inventive concepts are not limited thereto. For example, the second fastening unit 540 may include a snap-fit member fastened to the base unit 300 in a catch fixing manner.

FIG. 18A is a view schematically illustrating a surface intensity of illumination of a lighting device according to an embodiment of the present inventive concepts, and FIG. 18B is a graph schematically showing a light distribution curve.

As shown in the graph of a light distribution curve, it can be seen that light is also irradiated backwardly, as well as forwardly, on the basis of an optical axis, thereby providing rearward light distribution. In the case of the light distribution, a quantity of light irradiated laterally and backwardly is reduced, relative to a quantity of forwardly irradiated light, but it can be seen that the distribution is relatively uniform overall.

FIG. 19 illustrates a modification of the light spreading unit. As illustrated in FIG. 19, a light spreading unit 200′ may include a reflective member 220 formed on a portion of the lower surface 202.

The reflective member 220 serves to increase a quantity of light, moving forwardly, i.e., toward the upper surface 201, included in light irradiated outwardly through the light spreading unit 200′. In this case, since the reflective member 220 serves to increase a quantity of light moving forwardly, relative to a quantity of light moving backwardly, the reflective member 220 may not need to have a structure for completely reflecting light to block light from being irradiated backwardly. Thus, the reflective member 220 may have light transmittance and reflectivity to a degree and may be formed to cover a portion of the lower surface 202.

Adjustment of a quantity of light may be implemented through the structure of the lower surface 202 itself, i.e., a curved surface, to a degree. Thus, the reflective member 220 may be optional.

The reflective member 220 may be formed by applying white paint or a reflective material to the lower surface 202 or may be formed as a sheet and attached. The reflective material may include a white powder formed of a material of one or more selected from the group consisting of SiO₂, TiO₂, Al₂O₃, or the like. The reflective material may be contained in a resin, or the like, so as to be applied or attached.

Also, the reflective member 220 may be formed by directly processing the lower surface 202. For example, the lower surface 202 may be subjected to sand blasting to have fine roughness formed thereon, and the lower surface 202 may itself be processed to be opaque or translucent.

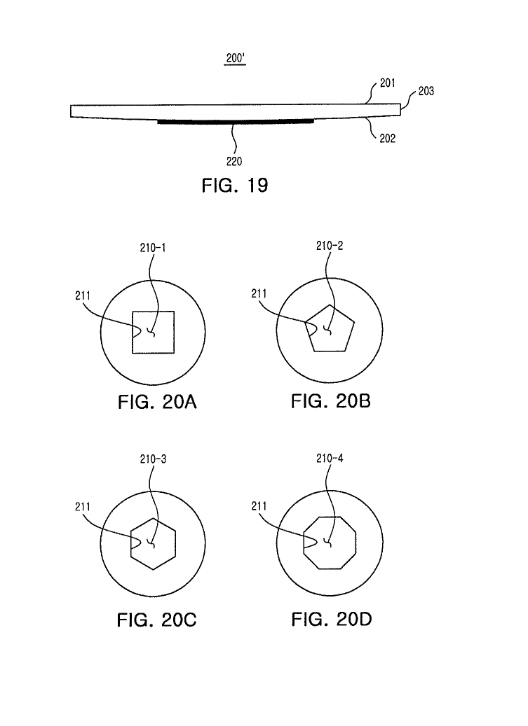

FIGS. 20(a) through 20(d) are plan views schematically illustrating a modification of the light spreading unit. The light spreading unit according to a modification illustrated in FIGS. 20(a) through 20(d) has a structure substantially the same as that of the embodiment illustrated in FIGS. 1 and 2, except for the structure of the accommodation hole 210 of the light spreading unit 200. Thus, hereinafter, descriptions the same as those of the former embodiment will be omitted and the structure of the accommodation hole will be described.

In FIGS. 1 and 2, the inner surface 211 of the accommodation hole 210 is illustrated as having a circular shape corresponding to the shape of the outer surface 203 of the light spreading unit 200. However, the present inventive concepts are not limited to the structure in which the inner surface 211 of the accommodation hole 210 of the light spreading unit 200 has a circular shape. For example, as illustrated in FIG. 20(a), the inner surface 211 of an accommodation hole 210-1 may have a quadrangular structure. Namely, the inner surface 211 may have a quadrangular structure corresponding to the structure of the light source 100 having a quadrangular annular structure.

Also, as illustrated in FIG. 20(b), the inner surface 211 of an accommodation hole 210-2 may have a pentagonal structure. Also, as illustrated in FIG. 20(c), the inner surface 211 of an accommodation hole 210-3 may have a hexagonal structure. As illustrated in FIG. 20(d), the inner surface 211 of an accommodation hole 210-4 may have an octagonal structure. Accordingly, the inner surface 211 may have various polygonal structures.

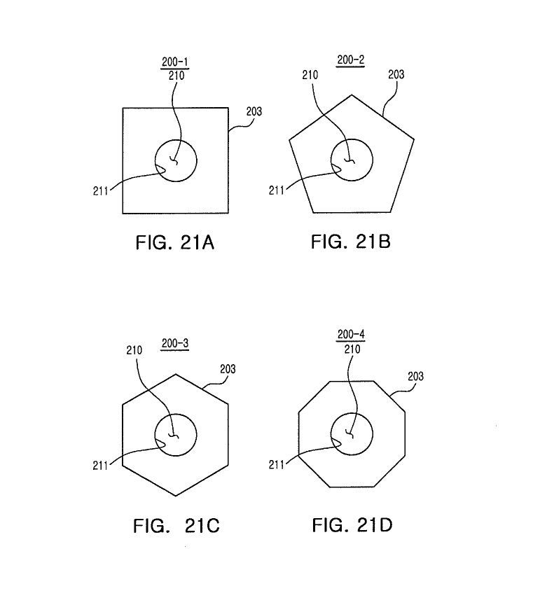

FIGS. 21(a) through 21(d) are plan views schematically illustrating another modification of the light spreading unit of FIG. 1. The light spreading unit according to a modification illustrated in FIGS. 21(a) through 21(d) has substantially the same structure as that of the embodiment illustrated in FIGS. 1 and 2, except for the structure of the outer surface of the light spreading unit 200. Thus, hereinafter, a description of the same configuration as that of the former embodiment will be omitted and the structure of the outer surface of the light spreading unit will be described.

In FIGS. 1 and 2, the outer surface 203 of the light spreading unit 200 is illustrated to have a circular structure. However, the present inventive concepts are not limited to the structure in which the outer surface of the light spreading unit has a circular structure. For example, as illustrated in FIG. 21(a), the outer surface 203 of a light spreading unit 200-1 may have a quadrangular shape. Namely, the outer surface 203 of a light spreading unit 200-1 may have a quadrangular structure to correspond to the structure of the light source 100 having a quadrangular annular structure.

Also, as illustrated in FIG. 21(b), the outer surface 203 of the light spreading unit 200-2 may have a pentagonal structure. Also, as illustrated in FIG. 21(c), the outer surface 203 of the light spreading unit 200-3 may have a hexagonal structure. Also, as illustrated in FIG. 21(d), the outer surface 203 of the light spreading unit 200-4 may have an octagonal structure. Accordingly, the outer surface 203 may have various other polygonal structures.

The structure of the inner surface 211 of the accommodation hole 210 is not limited to the circular structure as illustrated but may be variously modified as illustrated in FIGS. 20(a) through 20(d).

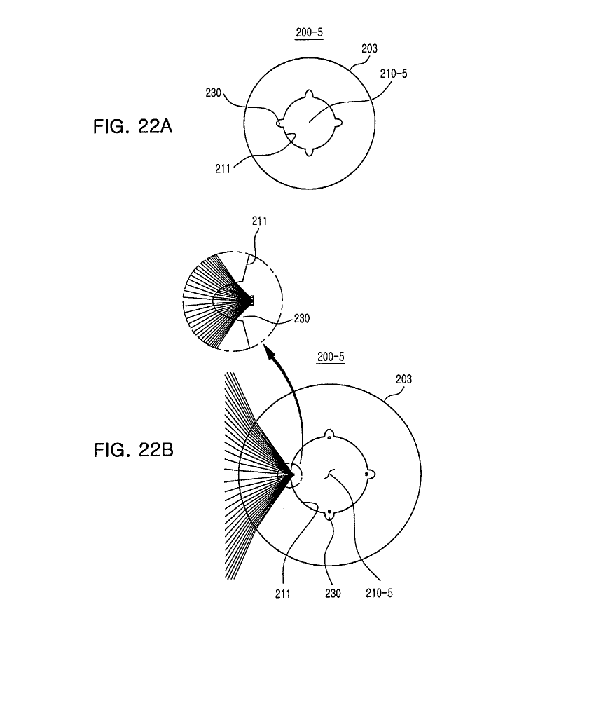

FIGS. 22A and 22B illustrate another embodiment of the light spreading unit. The light spreading unit according to a modification illustrated in FIGS. 22A and 22B has substantially the same structure as that of the embodiment illustrated herein, for example in the embodiments of FIGS. 1, 2, 20, and 21, except for a structure of an inner surface of the accommodation hole. Thus, hereinafter, a description of the same configuration as that of the former embodiment will be omitted and the structure of the inner surface of the accommodation hole will be described.

As illustrated in FIGS. 22A and 22B, the inner surface 2211 of an accommodation hole 210-5 of a light spreading unit 200-5 may have a light refractive structure 230 allowing light incident to the interior of the light spreading unit 200-5 to be spread more widely.

The light refractive structure 230 may include a concave-shaped recess formed on the inner surface 211 of the light spreading unit 200-5. A plurality of light refractive structures 230 having the recessed shape may be formed along the circumference of the inner surface 211 and face the light source unit 100.

Meanwhile, a fine protrusion may be further formed on a surface of the light refractive structure 230, i.e., the recess.

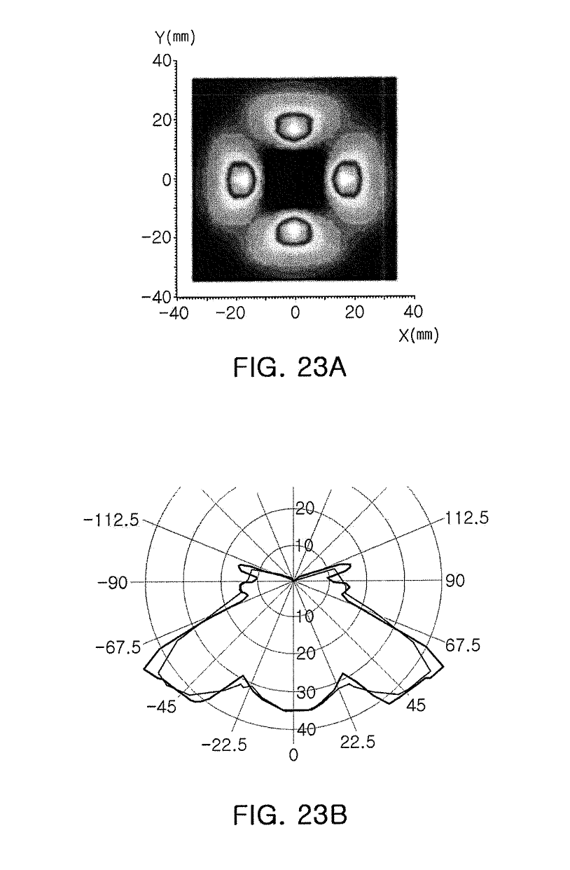

FIG. 23A is a view schematically illustrating surface intensity of illumination of the light emitting element according to the embodiment of FIG. 22A, and FIG. 23B is a graph schematically showing a light distribution curve.

As shown in the graph of a light distribution curve, it can be seen that light is also irradiated backwardly, as well as forwardly, on the basis of an optical axis, providing rearward light distribution. However, unlike the case of FIG. 18B, in the case of light distribution, a quantity of light irradiated forwardly is reduced, while a quantity of light irradiated laterally is relatively increased. This is because a quantity of light spread in the lateral direction is increased within the light spreading unit 200-5 due to the light refractive structure 230, so the quantity of light energy irradiated in a lateral direction is increased. An effect of the light distribution can be confirmed through a surface intensity of illumination illustrated in FIG. 23A. Namely, in comparison to the case of FIG. 18A, light irradiated between light emitting elements is increased, obtaining an overall uniform intensity of illumination. Here, however, in comparison to the case of FIG. 18B, rearward light distribution is relatively reduced.

The lighting device according to an embodiment of the present inventive concepts has an advantage in that a structure of the light spreading unit 200 may be selectively used according to a lighting design. Namely, a lighting design which greatly requires rearward light distribution may employ the light spreading units 200, 200-1, 200-2, 200-3, and 200-4 having the structures illustrated in FIGS. 1, 2, and 19 to 21. Also, a lighting design which greatly requires a lateral light distribution may employ the light spreading unit 200-5 having the structure illustrated in FIG. 22. Also, the light spreading units 200, 200-1, 200-2, 200-3, 200-4, and 200-5 may be easily replaced by fastening the heat dissipating unit 400 and the housing unit 500.

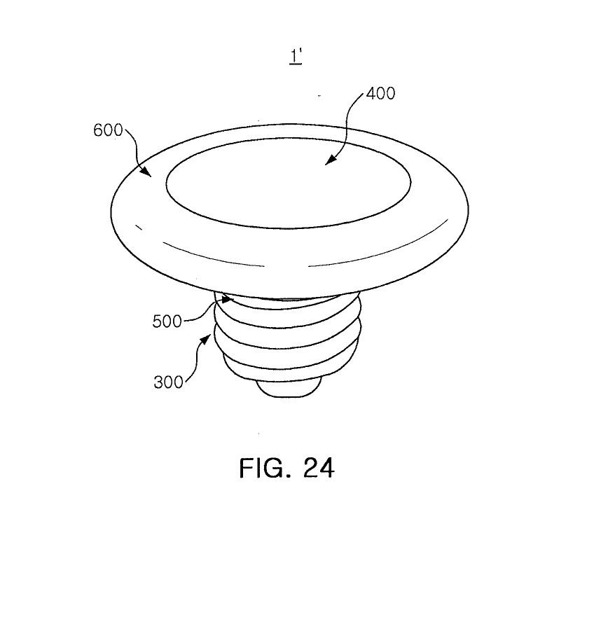

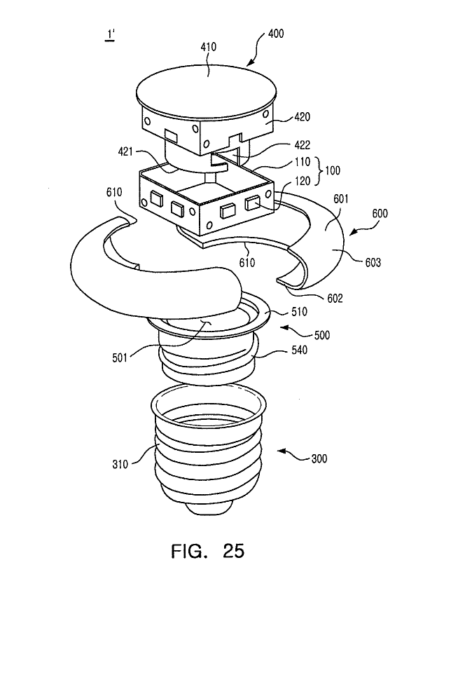

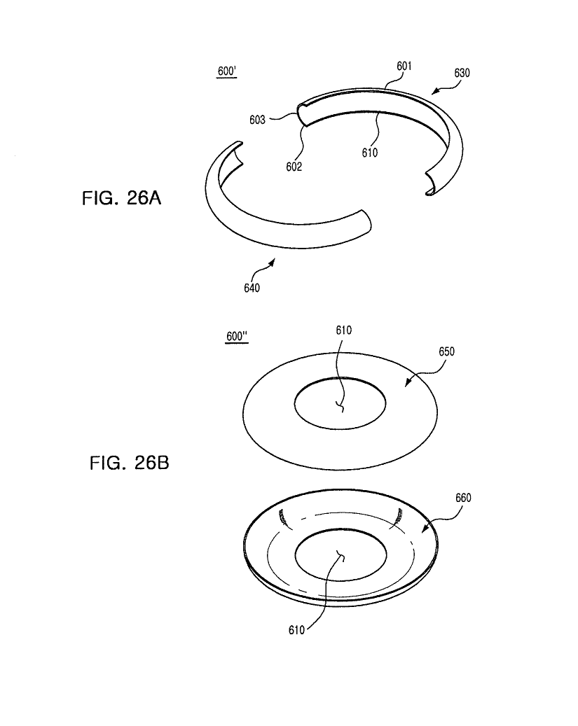

A lighting device according to another embodiment of the present inventive concepts will be described with reference to FIGS. 24 through 26. FIG. 24 is a perspective view schematically illustrating a lighting device according to another embodiment of the present inventive concepts. FIG. 25 is an exploded perspective view schematically illustrating the lighting device of FIG. 24. FIGS. 26A and 26B are exploded perspective views schematically illustrating various embodiments of a light spreading unit of the lighting device of FIG. 25.

The light spreading unit according to an embodiment illustrated in FIGS. 24 through 26 basically has a substantially same structure as that of the embodiment illustrated in FIGS. 1 to 22, except for a structure of the light spreading unit. Thus, hereinafter, a description of the same configuration as that of the former embodiment will be omitted, and the structure of the light spreading unit will be described.

As illustrated in FIGS. 24 to 26, a lighting device 1′ according to another embodiment of the present inventive concepts may include the light source unit 100 irradiating light radially, a light spreading unit 600 allowing the radially irradiated light to be transmitted therethrough and emitted outwardly therefrom, and the base unit 300 supplying power to the light source unit 100. The lighting device 1′ may further include the heat dissipating unit 400 and the housing unit 500.

The light spreading unit 600 allows light radially irradiated from the light source unit 100 to be transmitted therethrough and emitted outwardly therefrom. Also, the light spreading unit 600 may expand a light distribution region such that the outwardly emitted light is irradiated laterally and backwardly, as well as forwardly.

The light spreading unit 600 may be made of a plastic material having transparency to allow light emitted from the light source unit 100 to be transmitted therethrough and irradiated outwardly. For example, the material may include polycarbonate (PC), polymethylmethacrylate (PMMA), and the like. Also, the light spreading unit 600 may be made of a glass material, however the present inventive concepts are not limited thereto.

The light spreading unit 600 may have a hollow structure. Namely, unlike the former embodiment in which the light spreading unit has a solid structure as illustrated in FIGS. 1 through 22, the light spreading unit 600 according to the present embodiment may have a hollow structure to form an internal space for accommodating the light source unit therein.

The light spreading unit 600 may include an upper surface 601, a lower surface 602, and an outer surface 603 connecting the upper surface 601 and the lower surface 602, and may have an overall slim plate structure. In this case, a thickness defined by the upper surface 601 and the lower surface 602 of the light spreading unit 600 may correspond to a thickness of the light source unit 100. Namely, the light spreading unit 600 may have a thickness corresponding to a height of the vertically positioned board 110. Accordingly, the overall lighting device 1′ can be made to have a thinner profile.

In the present disclosure, terms such as ‘upper portion’, ‘lower portion’, ‘upper surface’, ‘lower surface’, ‘lateral surface’, and the like, are determined based on the drawings, and in actuality, the terms may be changed according to a direction in which the lighting device is disposed.

The upper surface 601 and the lower surface 602 may have portions that are substantially parallel to each other. The outer surface 603 may be gently curved. The light spreading unit 600 may have an accommodation hole 610 formed in the center thereof and penetrating the upper surface 601 and the lower surface 602. The upper surface 601 and the lower surface 602 may radially extend from the accommodation hole 610 to the outer surface 603 away from the accommodation hole 610 by a predetermined distance. Accordingly, the light spreading unit 600 may have a slim overall structure having a tire-like shape in which the accommodation hole 610 penetrates the center of the slim plate structure. Through the accommodation hole 610, the light source unit 100 may be accommodated and disposed in the internal space.

The light spreading unit 600 may have a structure divided into a plurality of section members. Namely, the light spreading unit 600 may be configured by combining the section members. As illustrated in FIG. 26A, the light spreading unit 600′ may have a structure in which section members 630 and 640 are divided horizontally to be symmetrical. Also, as illustrated in FIG. 26B, a light spreading unit 600″ may have a structure in which section members 650 and 660 are divided vertically to be symmetrical.

In the present embodiment, it is illustrated that the light spreading units 600′ and 600″ include a plurality of section members 630, 640, 650, and 660, but the present inventive concepts are not limited thereto. For example, the light spreading unit 600, 600′, and 600″ may have a singular, unitary, structure.

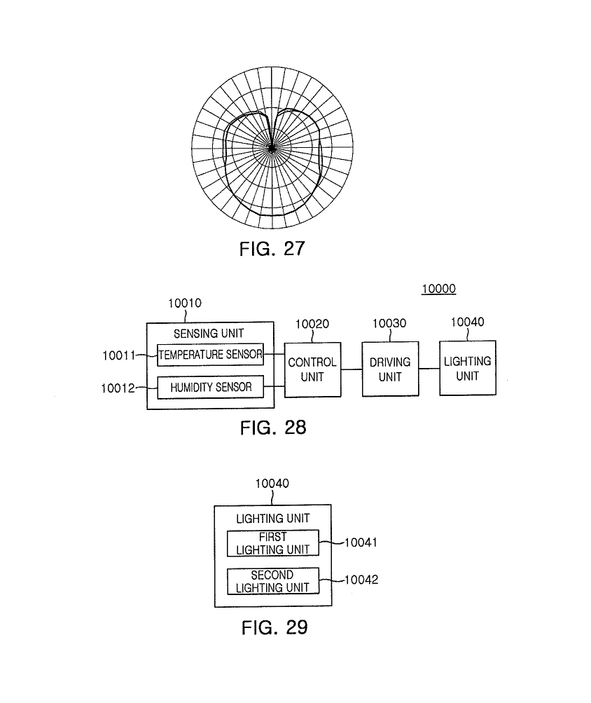

FIG. 27 is a graph showing a light distribution curve of a lighting device of the type depicted in a FIGS. 24-26. Referring to the graph showing a light distribution curve, it can be seen that light is irradiated laterally and backwardly, as well as forwardly, on the basis of an optical axis, providing rearward light distribution. In this light distribution, a quantity of light irradiated laterally and backwardly is reduced, relative to a quantity of forwardly irradiated light, but, unlike the light distribution curve illustrated in FIG. 18B, an overall smooth distribution is evident.

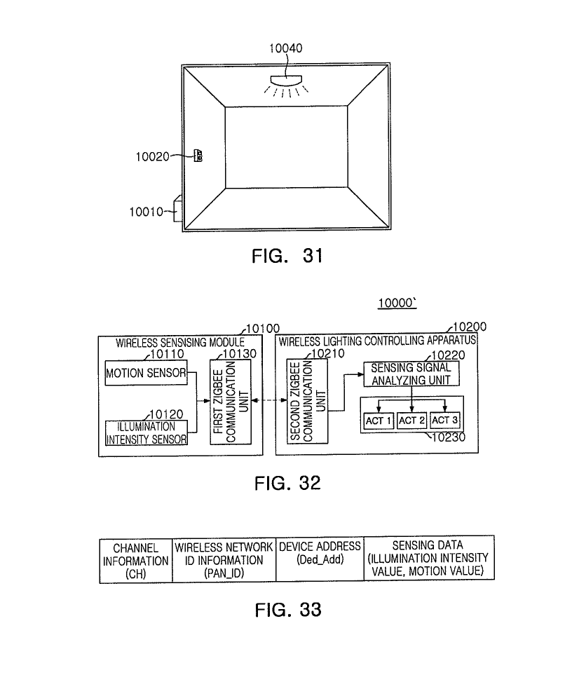

A lighting system using the lighting device as described above with reference to FIGS. 28 and 31 will be described. The lighting system according to the present embodiment may be able to provide a lighting device having sensitivity (or emotional) illumination that is able to automatically adjust a color temperature according to a surrounding environment (e.g., temperature and humidity conditions) and to suit human needs, rather than serving as a simple illumination device.

FIG. 28 is a block diagram schematically illustrating a lighting system according to an embodiment of the present inventive concepts.

Referring to FIG. 28, a lighting system 10000 according to an embodiment of the present inventive concepts may include a sensing unit 10010, a control unit 10020, a driving unit 10030, and a lighting unit 10040.

The sensing unit 10010 may be installed in an indoor or outdoor area, and may have a temperature sensor 10011 and a humidity sensor 10012 to measure at least one air condition among ambient temperature and humidity. The sensing unit 10010 transmits the measured at least one air condition, i.e., at least one of temperature and humidity, to the control unit 10020 electrically connected thereto.

The control unit 10020 may compare the temperature and humidity of the measured air with air condition settings (a temperature and a humidity range) previously set by a user, and determine a color temperature of the lighting unit 10040 corresponding to the air condition according to the comparison results. The control unit 10020 is electrically connected to the driving unit 10030, and controls the driving unit 10030 to drive the lighting unit 10040.

The lighting unit 10040 operates according to power supplied by the driving unit 1003. The lighting unit 10040 may include at least one lighting device illustrated in FIG. 1. For example, as illustrated in FIG. 29, the lighting unit 10040 may include a first lighting device 10041 and a second lighting device 10042 having different color temperatures, and each of the lighting devices 10041 and 10042 may include a plurality of light emitting elements emitting the same white light.

The first lighting device 10041 may emit white light having a first color temperature, and the second lighting device 10042 may emit white light having a second color temperature. In this case, the first color temperature may be lower than the second color temperature. Conversely, the first color temperature may be higher than the second color temperature. Here, white light having a relatively low color temperature corresponds to warm white light, and white light having a relatively high color temperature corresponds to cold white light. When power is supplied to the first and second lighting devices 10041 and 10042, the first and second lighting devices 10041 and 10042 emit white light having a first color temperature and a second color temperature, respectively, and the respective white light beams are mixed to implement white light having a color temperature determined by the control unit 10020.

In detail, in a case in which the first color temperature is lower than the second color temperature, if a color temperature determined by the control unit 10020 is relatively high, a quantity of light of the first lighting device 10041 may be reduced and that of the second lighting device 10042 may be increased to implement mixed white light having the predetermined color temperature. Conversely, when the predetermined color temperature is relatively low, a quantity of the first lighting device 10041 may be increased and that of the second lighting device 10042 may be reduced to implement mixed white light having the predetermined color temperature. Here, the quantity of light of the respective lighting devices 10041 and 10042 may be implemented by adjusting a quantity of light of the entire light emitting elements by regulating power, or may be implemented by adjusting the amount of light emitting elements driven.

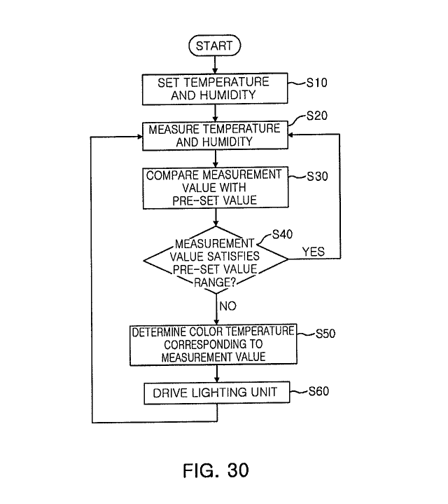

FIG. 30 is a flow chart illustrating a method for controlling the lighting system illustrated in FIG. 28. Referring to FIG. 30, first, a user sets a color temperature according to a temperature and humidity range through the control unit 10020 (S10). The set temperature and humidity data is stored in the control unit 10020.

In general, when a color temperature is equal to or more than 6000K, a color providing a cool feeling, such as blue, may be produced, and when a color temperature is less than 4000K, a color providing a warm feeling, such as red, may be produced. Thus, in the present embodiment, when a temperature and humidity exceed 20° C. and 60%, respectively, the user may set the lighting unit 10040 to be turned on to have a color temperature higher than 6000K through the control unit 10020, when a temperature and humidity range from 10° C. to 20° C. and 40% to 60%, respectively, the user may set the lighting unit 10040 to be turned on to have a color temperature ranging from 4000K to 6000K through the control unit 10020, and when a temperature and humidity are lower than 10° C. and 40%, respectively, the user may set the lighting unit 10040 to be turned on to have a color temperature lower than 4000K through the control unit 10020.

Next, the sensing unit 10010 measures at least one condition among ambient temperature and humidity (S20). The temperature and humidity measured by the sensing unit 10010 are transmitted to the control unit 10020.

Subsequently, the control unit 10020 compares the measurement values transmitted from the sensing unit 10010 with pre-set values (S30). Here, the measurement values are temperature and humidity data measured by the sensing unit 10010 and the pre-set values are temperature and humidity values previous set by the user and stored in the control unit 10020. Namely, the control unit 10020 compares the measured temperature and humidity levels with pre-set temperature and humidity levels.

The control unit 10020 determines whether the measurement values satisfy pre-set value ranges (S40). When the measurement values satisfy the pre-set value ranges, the control unit 10020 maintains a current color temperature, and continues to measure temperature and humidity (S20). Meanwhile, when the measurement values do not satisfy the pre-set value ranges, the control unit 10020 detects pre-set values corresponding to the measurement values and determines a corresponding color temperature (S50). Thereafter, the control unit 10020 controls the driving unit 10030 to drive the lighting unit 10040 to have the predetermined color temperature.

Then, the driving unit 10030 drives the lighting unit 10040 to have the predetermined color temperature (S60). Namely, the driving unit 10030 supplies required power to drive the lighting unit 10040 to implement the predetermined color temperature. Accordingly, the lighting unit 10040 may be adjusted to have a color temperature corresponding to the temperature and humidity previously set by the user according to ambient temperature and humidity.

In this manner, the lighting system is able to automatically regulate a color temperature of the indoor lighting unit according to changes in ambient temperature and humidity, thereby satisfying human moods varied according to changes in the surrounding natural environment and providing psychological stability.

FIG. 31 is a view schematically illustrating the use of the lighting system illustrated in FIG. 28. As illustrated in FIG. 31, the lighting unit 10040 may be installed on the ceiling as an indoor lamp. Here, the sensing unit 10010 may be implemented as a separate device and installed on an outer wall in order to measure outdoor temperature and humidity. The control unit 10020 may be installed in an indoor area to allow the user to easily perform setting and ascertainment operations. However, the lighting system according to an embodiment of the present inventive concepts are not limited thereto and may be installed on the wall in the place of an interior illumination device or may be applicable to a lamp, such as a desk lamp, or the like, that can be used in indoor and outdoor areas.

Another example of a lighting system using the foregoing lighting device will be described with reference to FIGS. 32 through 35. The lighting system according to the present embodiment may automatically perform a predetermined control by detecting a motion of a monitored target and an intensity of illumination at a location of the monitored target and automatically perform the predetermined control.

FIG. 32 is a block diagram of a lighting system according to another embodiment of the present inventive concepts.

Referring to FIG. 32, a lighting system 10000′ according to the present embodiment includes a wireless sensing module 10100 and a wireless lighting controlling apparatus 10200.

The wireless sensing module 10100 may include a motion sensor 10100, an illumination intensity sensor 10120 sensing an intensity of illumination, and a first wireless communications unit generating a wireless signal that includes a motion sensing signal from the motion sensor 10110 and an illumination intensity sensing signal from the illumination intensity sensor 10120 and that complies with a predetermined communications protocol, and transmitting the same. The first wireless communications unit may be configured as a first ZigBee communication unit 10130 generating a ZigBee signal that complies with a pre-set communications protocol and transmitting the same.

The wireless lighting controlling apparatus 10200 may include a second wireless communications unit receiving a wireless signal from the first wireless communications unit and restoring a sensing signal, a sensing signal analyzing unit 10220 analyzing the sensing signal from the second wireless communication unit, and an operation control unit 10230 performing a predetermined control based on analysis results from the sensing signal analyzing unit 10220. The second wireless communication unit may be configured as a second ZigBee communication unit 10210 receiving a ZigBee signal from the first ZigBee communication unit and restoring a sensing signal.

FIG. 33 is a view illustrating a format of a ZigBee signal according to an embodiment of the present inventive concepts.

Referring to FIG. 33, the ZigBee signal from the first ZigBee communication unit 10130 may include channel information (CH) defining a communications channel, a wireless network identification (ID) information (PAN_ID) defining a wireless network, a device address (Ded_Add) designating a target device, and sensing data including the motion and illumination intensity signal.

Also, the ZigBee signal from the second ZigBee communication unit 10210 may include channel information (CH) defining a communications channel, a wireless network identification (ID) information (PAN_ID) defining a wireless network, a device address (Ded_Add) designating a target device, and sensing data including the motion and illumination intensity signal.

The sensing signal analyzing unit 10220 may analyze the sensing signal from the second ZigBee communication unit 10210 to detect a satisfied condition, among a plurality of conditions, based on the sensed motion and the sensed intensity of illumination.

Here, the operation control unit 10230 may set a plurality of controls based on a plurality of conditions that are previously set by the sensing signal analyzing unit 10220, and perform a control corresponding to the condition detected by the sensing signal analyzing unit 10220.

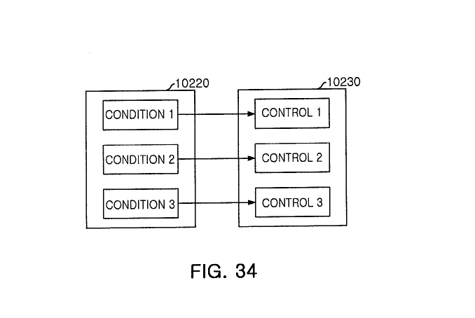

FIG. 34 is a view illustrating the sensing signal analyzing unit and the operation control unit according to an embodiment of the present inventive concepts. Referring to FIG. 34, for example, the sensing signal analyzing unit 10220 may analyze the sensing signal from the second ZigBee communication unit 10210 and detect a satisfied condition among first, second, and third conditions (condition 1, condition 2, and condition 3), based on the sensed motion and sensed intensity of illumination.

In this case, the operation control unit 10230 may set first, second and third controls (control 1, control 2, and control 3) corresponding to the first, second, and third conditions (condition 1, condition 2, and condition 3) previously set by the sensing signal analyzing unit 10220, and perform a control corresponding to the condition detected by the sensing signal analyzing unit 10220.

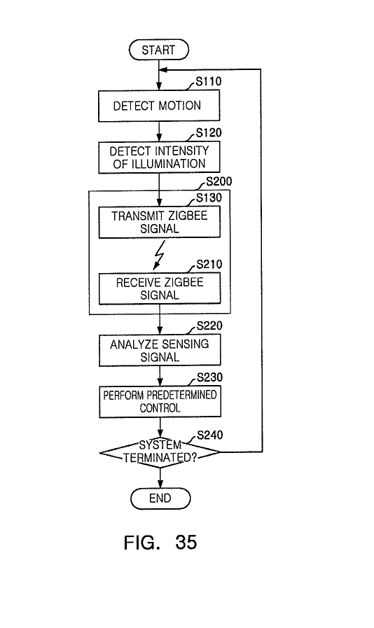

FIG. 35 is a flow chart illustrating an operation of a wireless lighting system according to an embodiment of the present inventive concepts.

In FIG. 35, in operation S110, the motion sensor 10110 detects a motion. In operation S120, the illumination intensity sensor 10120 detects an intensity of illumination. Operation S200 is a process of transmitting and receiving a ZigBee signal. Operation S200 may include operation S130 of transmitting a ZigBee signal by the first ZigBee communication unit 10130 and operation S210 of receiving the ZigBee signal by the second ZigBee communication unit 10210. In operation S220, the sensing signal analyzing unit 10220 analyzes a sensing signal. In operation S230, the operation control unit 10230 performs a predetermined control. In operation S240, whether the lighting system is terminated is determined.

Operations of the wireless sensing module and the wireless lighting controlling apparatus according to an embodiment of the present inventive concepts will be described with reference to FIGS. 32 through 35.

First, the wireless sensing module 10100 of the wireless lighting system according to an embodiment of the present inventive concepts will be described. The wireless lighting system 10100 according to an embodiment of the present inventive concepts are installed in a location in which a lighting device is installed, to detect a current intensity of illumination of the current of the lighting device and detect human motion near the lighting device.

Namely, the motion sensor 10110 of the wireless sensing module 10100 is configured as an infrared sensor, or the like, capable of sensing a human. The motion sensor 10100 senses a motion and provides the same to the first ZigBee communication unit 10130 (S110 in FIG. 35). The illumination intensity sensor 10120 of the wireless sensing module 10100 senses an intensity of illumination and provides the same to the first ZigBee communication unit 10130 (S120).

Accordingly, the first ZigBee communication unit 10130 generates a ZigBee signal that includes the motion sensing signal from the motion sensor 10100 and the illumination intensity sensing signal from the illumination intensity sensor 10120 and that complies with a pre-set communications protocol, and transmits the generated ZigBee signal wirelessly (S130).

Referring to FIG. 33, the ZigBee signal from the first ZigBee communication unit 10130 may include channel information (CH) defining a communications channel, a wireless network identification (ID) information (PAN_ID) defining a wireless network, a device address (Ded_Add) designating a target device, and sensing data, and here, the sensing data includes a motion value and an illumination intensity value.

Next, the wireless lighting controlling apparatus 10200 of the wireless lighting system according to an embodiment of the present inventive concepts will be described with reference to FIGS. 32 through 35. The wireless lighting controlling apparatus 10200 of the wireless lighting system according to an embodiment of the present inventive concepts may control a predetermined operation according to an illumination intensity value and a motion value included in a ZigBee signal from the wireless sensing module 10100.

Namely, the second ZigBee communication unit 10210 of the wireless lighting controlling apparatus 10200 according to an embodiment of the present inventive concepts receives a ZigBee signal from the first ZigBee communication unit 10130, restores a sensing signal therefrom, and provides the restored sensing signal to the sensing signal analyzing unit 10200 (S210 in FIG. 35).

Referring to FIG. 33, the ZigBee signal from the second ZigBee communication unit 10210 may include channel information (CH) defining a communications channel, a wireless network identification (ID) information (PAN_ID) defining a wireless network, a device address (Ded_Add) designating a target device, and sensing data. A wireless network may be identified based on the channel information (CH) and the wireless network ID information (PAN_ID), and a sensed device may be recognized based on the device address. The sensing signal includes the motion value and the illumination intensity value.

Also, referring to FIG. 32, the sensing signal analyzing unit 10220 analyzes the illumination intensity value and the motion value included in the sensing signal from the second ZigBee communication unit 10210 and provides the analysis results to the operation control unit 10230 (S220 in FIG. 35).

Accordingly, the operation control unit 10230 may perform a predetermined control according to the analysis results from the sensing signal analyzing unit 10220 (S230).

The sensing signal analyzing unit 10220 may analyze the sensing signal form the second ZigBee communication unit 10210 and detect a satisfied condition, among a plurality of conditions, based on the sensed motion and the sensed intensity of illumination. Here, the operation control unit 10230 may set a plurality of controls corresponding to the plurality of conditions set in advance by the sensing signal analyzing unit 10220, and perform a control corresponding to the condition detected by the sensing signal analyzing unit 10220.

For example, referring to FIG. 34, the sensing signal analyzing unit 10220 may detect a satisfied condition among the first, second, and third conditions (condition 1, condition 2, and condition 3) based on the sensed human motion and the sensed intensity of illumination by analyzing the sensing signal from the second ZigBee communication unit 10210.

In this case, the operation control unit 10230 may set first, second, and third controls (control 1, control 2, and control 3) corresponding to the first, second, and third conditions (condition 1, condition 2, and condition 3) set in advance by the sensing signal analyzing unit 10220, and perform a control corresponding to the condition detected by the sensing signal analyzing unit 10220.

For example, when the first condition (condition 1) corresponds to a case in which human motion is sensed at a front door and an intensity of illumination at the front door is not low (not dark), the first control may turn off all predetermined lamps. When the second condition (condition 2) corresponds to a case in which human motion is sensed at the front door and an intensity of illumination at the front door is low (dim), the second control may turn on some pre-set lamps (i.e., some lamps at the front door and some lamps in a living room). When the third condition (condition 3) corresponds to a case in which human motion is sensed at the door stop and an intensity of illumination at the front door is very low (very dark), the third control may turn on all the pre-set lamps.

Unlike the foregoing cases, besides the operation of turning lamps on or off, the first, second, and third controls may be variously applied according to pre-set operations. For example, the first, second, and third controls may be associated with operations of a lamp and an air-conditioner in summer or may be associated with operations of a lamp and heating in winter.

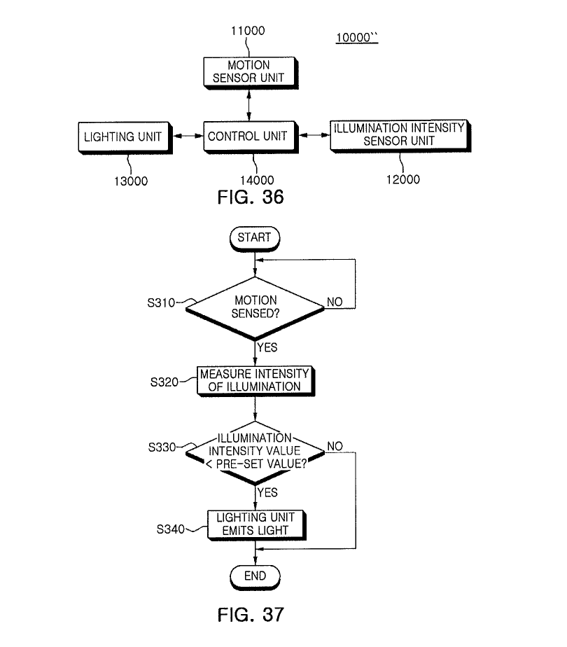

Another example of a lighting system using the foregoing lighting device will be described with reference to FIGS. 36 through 39.

FIG. 36 is a block diagram schematically illustrating constituent elements of a lighting system according to another embodiment of the present inventive concepts. A lighting system 10000″ according to the present embodiment may include a motion sensor unit 11000, an illumination intensity sensor unit 12000, a lighting unit 13000, and a control unit 14000.

The motion sensor unit 11000 senses a motion of an object. For example, the lighting system may be attached to a movable object, such as, for example, a container or a vehicle, and the motion sensor unit 11000 senses motion of the object that moves. When the motion of the object to which the lighting system is attached is sensed, the motion sensor unit 11000 outputs a signal to the control unit 14000 and the lighting system is activated. The motion sensor unit 11000 may include an accelerometer, a geomagnetic sensor, or the like.

The illumination intensity sensor unit 12000, a type of optical sensor, measures an intensity of illumination of a surrounding environment. When the motion sensor unit 11000 senses a motion of the object to which the lighting system is attached, the illumination intensity sensor unit 12000 is activated according to a signal output by the control unit 14000. The lighting system illuminates during night work or in a dark environment to call a worker or an operator's attention to their surroundings, and allows a driver to secure visibility at night. Thus, even when a motion of an object to which the lighting system is attached is sensed, if an intensity of illumination higher than a predetermined level is secured (during the day), the lighting system is not required to illuminate. Also, even in the daytime, if it rains, the intensity of illumination may be fairly low, so there is a need to inform a worker or an operator about a movement of a container, and thus, the lighting unit is required to emit light. Thus, a decision of whether to turn on the lighting unit 13000 is determined according to an illumination intensity value measured by the illumination intensity sensor unit 12000.

The illumination intensity sensor unit 12000 measures an intensity of illumination of a surrounding environment and outputs the measurement value to the control unit 14000 as described hereinafter. Meanwhile, when the illumination intensity value is equal to or higher than a pre-set value, the lighting unit 13000 is not required to emit light, so the overall system is terminated.

When the illumination intensity value measured by the illumination intensity sensor unit 12000 is lower than the pre-set value, the lighting unit 13000 emits light. The worker or the operator may recognize the light emissions from the lighting unit 1300 to recognize a movement of a container, or the like. As the lighting unit 13000, the foregoing lighting device may be employed.

Also, the lighting unit 13000 may adjust intensity of light emissions thereof according to the illumination intensity value of the surrounding environment. When the illumination intensity value of the surrounding environment is low, the lighting unit 13000 may increase the intensity of light emissions thereof, and when the illumination intensity value of the surrounding environment is relatively high, the lighting unit 13000 may decrease the intensity of light emissions thereof, thus preventing power wastage.

The control unit 14000 controls the motion sensor unit 1100, the illumination intensity sensor unit 12000, and the lighting unit 13000 overall. When the motion sensor unit 11000 senses a motion of an object to which the lighting system is attached, and outputs a signal to the control unit 14000, the control unit 14000 outputs an operation signal to the illumination intensity sensor unit 12000. The control unit 14000 receives an illumination intensity value measured by the illumination intensity sensor unit 12000 and determines whether to turn on (operate) the lighting unit 13000.

FIG. 37 is a flow chart illustrating a method for controlling a lighting system. Hereinafter, a method for controlling a lighting system will be described with reference to FIG. 37.

First, a motion of an object to which the lighting system is attached is sensed and an operation signal is output (S310). For example, the motion sensor unit 11000 may sense a motion of a container or a vehicle in which the lighting system is installed, and when a motion of the container or the vehicle is sensed, the motion sensor unit 11000 outputs an operation signal. The operation signal may be a signal for activating overall power. Namely, when a motion of the container or the vehicle is sensed, the motion sensor unit 11000 outputs an operation signal to the control unit 14000.

Next, based on the operation signal, an intensity of illumination of a surrounding environment is measured and an illumination intensity value is output (S320). When the operation signal is applied to the control unit 14000, the control unit 14000 outputs a signal to the illumination intensity sensor unit 12000, and the illumination intensity sensor unit 12000 then measures an intensity of illumination of the surrounding environment. The illumination intensity sensor unit 12000 outputs the measured illumination intensity value of the surrounding environment to the control unit 14000. Thereafter, whether to turn on the lighting unit is determined according to the illumination intensity value and the lighting unit emits light according to the determination.

First, the illumination intensity value is compared with a pre-set value for a determination. When the illumination intensity value is input to the control unit 14000, the control unit 14000 compares the received illumination intensity value with a stored pre-set value and determine whether the former is lower than the latter. Here, the pre-set value is a value for determining whether to turn on the lighting device. For example, the pre-set value may be an illumination intensity value at which a worker or a driver may have difficulty in recognizing an object with the naked eye or may make a mistake in a situation, for example, a situation in which the sun starts to set.

When the illumination intensity value measured by the illumination intensity sensor unit 12000 is higher than the pre-set value, lighting of the lighting unit is not required, so the control unit 14000 shuts down the overall system.

Meanwhile, when the illumination intensity value measured by the illumination intensity sensor unit 12000 is higher than the pre-set value, lighting of the lighting unit is required, so the control unit 14000 outputs a signal to the lighting unit 13000 and the lighting unit 13000 emits light (S340).

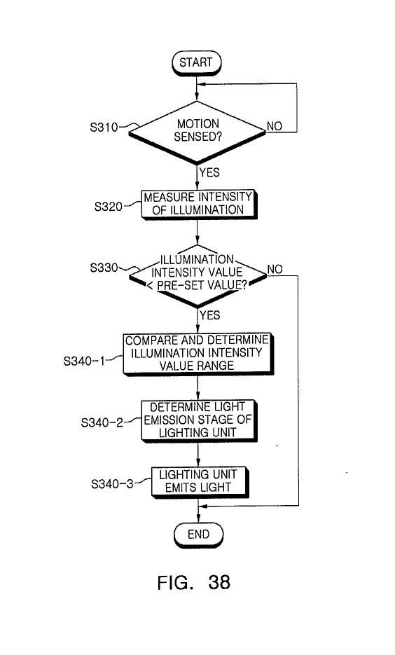

FIG. 38 is a flow chart illustrating a method for controlling a lighting system according to another embodiment of the present inventive concepts. Hereinafter, a method for controlling a lighting system according to another embodiment of the present inventive concepts will be described. However, the same procedure as that of the method for controlling a lighting system as described above with reference to FIG. 36 will be omitted.

As illustrated in FIG. 38, in the case of the method for controlling a lighting system according to the present embodiment, an intensity of light emissions of the lighting unit may be regulated according to an illumination intensity value of a surrounding environment.

As described above, the illumination intensity sensor unit 12000 outputs an illumination intensity value to the control unit 14000 (S320). When the illumination intensity value is lower than a pre-set value (S330), the control unit 14000 determines a range of the illumination intensity value (S340-1). The control unit 14000 has a range of subdivided illumination intensity value, based on which the control unit 14000 determines the range of the measured illumination intensity value.

Next, when the range of the illumination intensity value is determined, the control unit 14000 determines an intensity of light emissions of the lighting unit (S340-2), and accordingly, the lighting unit 13000 emits light (S340-3). The intensity of light emissions of the lighting unit may be divided according to the illumination intensity value, and here, the illumination intensity value varies according to weather, time, and surrounding environment, so the intensity of light emissions of the lighting unit may also be regulated. By regulating the intensity of light emissions according to the range of the illumination intensity value, power wastage can be prevented and a worker or an operator's attention may be drawn to their surroundings.

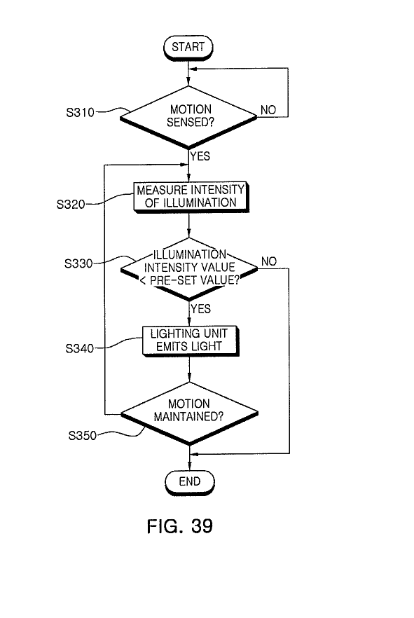

FIG. 39 is a flow chart illustrating a method for controlling a lighting system according to another embodiment of the present inventive concepts. Hereinafter, a method for controlling a lighting system according to another embodiment of the present inventive concepts will be described. However, the same procedure as that of the method for controlling a lighting system as described above with reference to FIGS. 37 and 38 will be omitted.

The method for controlling a lighting system according to the present embodiment further includes operation S350 of determining whether a motion of an object to which the lighting system is attached is maintained in a state in which the lighting unit 13000 emits light, and determining whether to maintain light emissions.

First, when the lighting unit 13000 starts to emit light, termination of the light emissions may be determined based on whether a container or a vehicle to which the lighting system is installed moves. Here, when a motion of the container is stopped, it may be determined that an operation thereof has terminated. In addition, when a vehicle temporarily stops at a crosswalk, light emissions of the lighting unit may be stopped to prevent interference with vision of oncoming drivers.

When the container or the vehicle moves again, the motion sensor unit 11000 operates and the lighting unit 14000 may start to emit light.

Whether to maintain light emissions may be determined based on whether a motion of an object to which the lighting system is attached is sensed by the motion sensor unit 11000. When a motion of the object continuously sensed by the motion sensor unit 11000, an intensity of illumination is measured again and whether to maintain light emissions is determined. Meanwhile, when a motion of the object is not sensed, the system is terminated.

As set forth above, according to embodiments of the inventive concepts, the lighting device capable of implementing a light distribution, like an existing illumination light source, in spite of using an LED as a light source is provided.

Also, the lighting device having a size reduced by a relatively compact and thin structure, unlike an existing light source, is provided.

While the present inventive concepts have been shown and described in connection with the embodiments, it will be apparent to those skilled in the art that modifications and variations can be made without departing from the spirit and scope of the inventive concepts as defined by the appended claims.

What is claimed is:

1. A light emitting device comprising:
a substrate having first and second power terminals, the substrate constructed and arranged to at least partially surround an inner region, the substrate having an inner surface that faces the inner region and an outer surface opposite the inner region; and
a plurality of light emitting elements positioned on the outer surface of the substrate and electrically connected to the first and second power terminals, the plurality of light emitting elements positioned on the outer surface so that first and second ones of the light emitting elements are arranged to emit light radiation that is substantially oriented in first and second different radial directions, respectively, relative to the inner region.

2. The light emitting device of claim 1 wherein a vertical axis of the device intersects the inner region and wherein the plurality of light emitting elements are positioned on a common plane that intersects the vertical axis.

3. The light emitting device of claim 1 further comprising a light spreading unit positioned to receive incident light radiation in the first and second radial directions from the first and second light emitting elements.

4. The light emitting device of claim 3 wherein the light spreading unit comprises an intermediate opening having an inner surface and wherein the substrate including the first and second light emitting elements is positioned in the intermediate opening so that the light radiation from the first and second light emitting elements is incident on the inner surface of the intermediate opening.

5. The light emitting device of claim 4 further comprising light refractive structures at the intermediate opening.

6. The light emitting device of claim 5 wherein the light refractive structures have positions that correspond with positions of the light emitting elements.

7. The light emitting device of claim 3 wherein the light spreading unit further comprises an upper surface and a lower surface and wherein at least one of the upper surface and lower surface is curved so as to redirect internally propagating light.

8. The light emitting device of claim 3 wherein the light spreading unit comprises a unitary disc including the intermediate opening.

9. The light emitting device of claim 3 wherein the light spreading unit comprises a substantially toroidal structure including the intermediate opening.

10. The light emitting device of claim 9 wherein a body of the toroidal structure is hollow.

11. The light emitting device of claim 3 wherein the light spreading unit is removably coupled to the light emitting device.

12. The light emitting device of claim 1 wherein the substrate has an outer shape that is one of three-sided, four-sided, five-sided, six-sided, seven-sided, eight-sided, nine-sided, or ten-sided, or greater-than-ten-sided.

13. The light emitting device of claim 1 further comprising:
a base at a first end of the light emitting device, the base having first and second terminals electrically insulated from each other, the first and second power terminals of the flexible substrate electrically connected to the first and second terminals of the base; and
a heat dissipating unit that dissipates heat generated by the light emitting device, a portion of the heat dissipating unit at an outermost second end of the light emitting device distal the first end.

14. The light emitting device of claim 1 wherein the curved surface is constructed and arranged so that the light spreading unit has a thickness that is greatest at an intermediate portion thereof and that is least at an outer portion thereof.

15. A light emitting device, comprising:
a base having first and second power terminals electrically insulated from each other;
a light source having a plurality of light emitting elements connected to the first and second terminals, the light source constructed and arranged to emit electromagnetic radiation in a radial direction relative to a first axis, all of the light emitting elements of the light source being positioned exclusively along a single plane that is normal to the first axis; and
a light spreading unit including an upper surface, a lower surface and an intermediate opening, the light spreading unit positioned about the light source to receive and distribute incident electromagnetic radiation from the light source at the intermediate opening.

16. The light emitting device of claim 15 wherein the base is at a first proximal end and further comprising:
a heat dissipating unit that dissipates heat generated by the light source, a portion of the heat dissipating unit at an outermost second end of the light emitting device distal the first end.

17. A light emitting device, comprising:
a base at a first end having first and second terminals electrically insulated from each other;
a light source having a plurality of light emitting elements connected to the first and second terminals, the light source constructed and arranged to emit electromagnetic radiation in a radial direction relative to a first axis,
a light-spreading unit including an upper surface, a lower surface and an intermediate opening, the light spreading unit positioned to receive incident electromagnetic radiation from the light source at the intermediate opening; and
a heat dissipating unit, a portion of the heat dissipating unit at an outermost second end of the light emitting device distal the first end.

18. The light emitting device of claim 17 wherein the light spreading unit being positioned at a position along the first axis of the light emitting device between the heat dissipating unit and the base.

19. The light emitting device of claim 17 wherein the light spreading unit is removably coupled to the light emitting device.

20. A light emitting device, comprising:
a base at a first end having first and second terminals electrically insulated from each other;
a light source having a plurality of light emitting elements connected to the first and second terminals, the light source constructed and arranged to emit electromagnetic radiation in a radial direction relative to a first axis, wherein the light source comprises light emitting elements, and wherein the elements are positioned exclusively on a single common plane that is normal to the first axis;
a light-spreading unit including an upper surface, a lower surface and an intermediate opening, the light spreading unit positioned to receive incident electromagnetic radiation from the light source at the intermediate opening, the light spreading unit comprising a substantially toroidal structure; and
a heat dissipating unit, a portion of the heat dissipating unit at an outermost second end of the light emitting device distal the first end.
